(19) United States
(12) Patent Application Publication
(10) Pub. No.: US 2025/0373739 A1
(43) Pub. Date: Dec. 4, 2025

(54) NON-TRANSITORY COMPUTER-READABLE STORAGE MEDIUM STORING PROGRAM WHICH SUPPORTS FUNCTION OF UNIVERSAL SCAN SOFTWARE, CONTROL METHOD FOR INFORMATION PROCESSING APPARATUS, AND INFORMATION PROCESSING APPARATUS

(71) Applicant: CANON KABUSHIKI KAISHA, Tokyo (JP)

(72) Inventor: RYO DEGAWA, Ibaraki (JP)

(21) Appl. No.: 19/216,551

(22) Filed: May 22, 2025

(30) Foreign Application Priority Data
May 29, 2024 (JP) 2024-087100

(51) Int. Cl. H04N 1/00; H04N 1/407

(52) U.S. Cl. CPC H04N 1/00482; H04N 1/0044; H04N 1/00503; H04N 1/407

(57) ABSTRACT

A non-transitory computer-readable storage medium stores an application program which causes an information processing apparatus to perform a control method, the control method including displaying a display screen for receiving a setting for adjusting contrast or brightness of an image which is scanned by an image processing device, and outputting, with use of universal scan software, a scan instruction for causing the image processing device to perform scanning of an image according to the setting received via the display screen. The application program supports the universal scan software, which is capable of outputting a scan instruction interpretable by a plurality of image processing devices from various manufacturers.

### BACKGROUND

### Field

Aspects of the present disclosure generally relate to a non-transitory computer-readable storage medium storing a program which supports the function of universal scan software, a control method for an information processing apparatus, and an information processing apparatus.

### Description of the Related Art

There is a known configuration which uses a scan driver installed on a host computer as software for controlling a scanning device and issues a scan instruction to the scanning device connected to the host computer. The host computer has an operating system (OS), serving as basic software, installed thereon, and the scan driver is configured according to the specifications specified by the OS and is invoked by the OS to run. The vendor (manufacturer) which provides a scanning device provides a scan driver compatible with the specifications of an OS, thus being able to provide a method or unit for issuing an instruction for scanning to the scanning device with use of the OS.

Recently, in Windows®, a standard class driver (hereinafter also referred to as a “standard driver”) which is able to be used in common by respective scanning devices provided by a plurality of vendors has been about to be provided. Such a standard driver is included in the package of an OS and easily becomes usable by connecting an optional scanning device to a host computer. Therefore, it is not necessary to separately install a device-specific scan driver adapted for the scanning device, so that the standard driver is highly convenient. Moreover, the standard driver is expected to be configured in such a way as to allow designating a scan function according to scan function information generated based on information acquired from the connected scanning device. This enables a user who uses the standard driver to, regardless of currently using one standard driver, designate a scan function corresponding to the capability of the connected scanning device. However, since the designated scan function stays within functions which are feasible only by the standard driver, the user is unable to designate a function specific to a scanning device vendor (manufacturer).

In this connection, Japanese Patent Application Laid-Open No. 2021-033526 discusses a program for extending the print function of universal software.

Here, the function of a scan driver specific to a scanning device vendor includes image adjustment functions such as a contrast adjustment function and a brightness adjustment function. The contrast adjustment function is the function of adjusting contrast of a scanned image, and the brightness adjustment function is the function of adjusting brightness of a scanned image.

However, in the case of using the standard driver, since the standard driver does not ensure the use of the contrast adjustment function or the brightness adjustment function, the user is unable to adjust contrast and brightness of an image.

### SUMMARY

Aspects of the present disclosure are generally directed to providing a contrivance which extends the function of universal scan software that is usable in common in scanning devices from various manufactures, and thus makes a contrast adjustment function and a brightness adjustment function available.

According to an aspect of the present disclosure, a non-transitory computer-readable storage medium stores an application program which causes an information processing apparatus to perform a control method, the control method including displaying a display screen for receiving a setting for adjusting contrast or brightness of an image which is scanned by an image processing device, and outputting, with use of universal scan software, a scan instruction for causing the image processing device to perform scanning of an image according to the setting received via the display screen, wherein the application program supports the universal scan software, which is capable of outputting a scan instruction interpretable by a plurality of image processing devices from various manufacturers.

Further features of the present disclosure will become apparent from the following description of exemplary embodiments with reference to the attached drawings.

### BRIEF DESCRIPTION OF THE DRAWINGS

FIG. 1 is a hardware configuration diagram of a scanning system in a first exemplary embodiment.

FIGS. 2A and 2B are software configuration diagrams of the scanning system in the first exemplary embodiment.

FIGS. 3A and 3B are diagrams illustrating a scan setting screen and an advanced setting screen, respectively, in the first exemplary embodiment.

FIGS. 3C and 3D are diagrams illustrating advanced setting screens in the first exemplary embodiment.

FIG. 4 is a flowchart illustrating editing processing for scan function information, which is performed by an extension application in the first exemplary embodiment.

FIG. 5A is a diagram illustrating lists of scan functions (contrast) of respective devices in the first exemplary embodiment.

FIG. 5B is a diagram illustrating lists of scan functions (brightness) of respective devices in the first exemplary embodiment.

FIG. 6 is a sequence diagram used to explain a scanning operation in the first exemplary embodiment.

FIG. 7 is a flowchart illustrating scan processing in the extension application in the first exemplary embodiment.

FIG. 8 is a flowchart illustrating scan processing in a scanning device in the first exemplary embodiment.

FIG. 9A is a flowchart illustrating addition processing for a contrast adjustment function in an extension application in a second exemplary embodiment.

FIG. 9B is a flowchart illustrating addition processing for a brightness adjustment function in the extension application in the second exemplary embodiment.

FIG. 10 is a sequence diagram used to explain a scanning operation in the second exemplary embodiment.

FIG. 11A is a flowchart illustrating scan processing in the extension application in the second exemplary embodiment.

FIG. 11B is a flowchart illustrating scan processing in the extension application in the second exemplary embodiment.

FIG. 12 is a sequence diagram used to explain a scanning operation in a third exemplary embodiment.

FIG. 13 is a sequence diagram used to explain a scanning operation in the third exemplary embodiment.

FIG. 14 is a sequence diagram used to explain a scanning operation in a fourth exemplary embodiment.

FIG. 15 is a flowchart illustrating scan processing in an extension application in the fourth exemplary embodiment.

FIGS. 16A and 16B are diagrams illustrating tables of capability information (contrast) in a fifth exemplary embodiment.

FIG. 16C is a diagram illustrating an example of an advanced setting screen which enables using a preview function (contrast adjustment) in the fifth exemplary embodiment.

FIGS. 16D and 16E are diagrams illustrating tables of capability information (brightness) in the fifth exemplary embodiment.

FIG. 16F is a diagram illustrating an example of an advanced setting screen which enables using a preview function (brightness adjustment) in the fifth exemplary embodiment.

FIG. 17 is a sequence diagram used to explain a scanning operation in the fifth exemplary embodiment.

FIG. 18 is a flowchart illustrating scan processing in an extension application in the fifth exemplary embodiment.

FIGS. 19A and 19B are flowcharts illustrating scan processing in the extension application in the fifth exemplary embodiment.

FIG. 20A is a diagram illustrating an example of an advanced setting screen which enables storing a preview image (contrast adjustment) in a sixth exemplary embodiment.

FIG. 20B is a diagram illustrating an example of an advanced setting screen which enables storing a preview image (brightness adjustment) in the sixth exemplary embodiment.

FIG. 21 is a sequence diagram used to explain a scanning operation in the sixth exemplary embodiment.

FIG. 22 is a flowchart illustrating scan processing in an extension application in the sixth exemplary embodiment.

FIG. 23 is a sequence diagram used to explain a scanning operation in the sixth exemplary embodiment.

FIG. 24 is a flowchart illustrating scan processing in the extension application in the sixth exemplary embodiment.

### DESCRIPTION OF THE EMBODIMENTS

Various exemplary embodiments, features, and aspects of the disclosure will be described in detail below with reference to the drawings. Furthermore, the following exemplary embodiments should not be construed to limit the present disclosure set forth in claims, and not all of the combinations of features described in the exemplary embodiments are essential for solutions in the present disclosure.

### [Hardware Configuration of Scanning System]

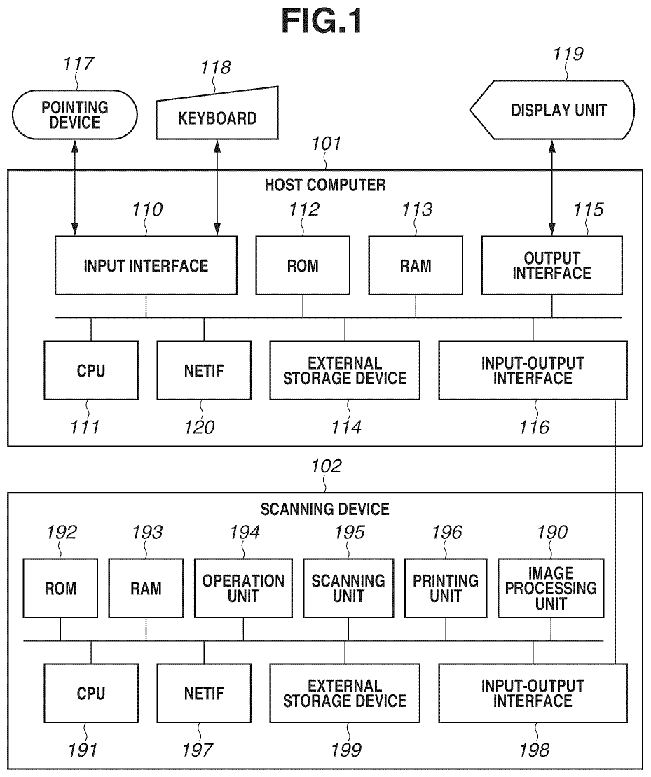

FIG. 1 is a block diagram illustrating a hardware configuration of a scanning system in a first exemplary embodiment of the present disclosure.

### <Host Computer>

Referring to FIG. 1, a host computer 101, which is an example of an information processing apparatus, includes an input interface 110, a central processing unit (CPU) 111, a read-only memory (ROM) 112, a random access memory (RAM) 113, an external storage device 114, an output interface 115, an input-output interface 116, and a network interface (hereinafter referred to as an “NETIF”) 120. Moreover, to the input interface 110, input devices, such as a keyboard 118 and a pointing device 117, are connected, and, to the output interface 115, a display device such as a display unit 119 is connected. The NETIF 120 performs control to perform data transfer with external equipment via a network.

An initialization program is stored in the ROM 112.

The external storage device 114 is, for example, a hard disk drive (HDD) or a solid state drive (SSD). An application program group, an operating system (OS), and other various pieces of data are stored in the external storage device 114.

The RAM 113 is used as, for example, a work memory to be used for execution of various programs stored in the external storage device 114, so that the various programs are able to run in the host computer 101.

Furthermore, in the first exemplary embodiment, the CPU 111 performs processing according to code of a program stored in the ROM 112, thus executing the respective functions described below in the host computer 101 and performing processing operations illustrated in the respective flowcharts described below.

### <Scanning Device>

A scanning device 102, which is an example of an image processing device, is connected to the host computer 101 via an input-output interface 198 of the scanning device 102 and the input-output interface 116 of the host computer 101. A wired network can be provided or a wireless network can be provided between the input-output interface 198 of the scanning device 102 and the input-output interface 116 of the host computer 101.

The scanning device 102, which is an image processing device, includes a CPU

191, a ROM 192, a RAM 193, an operation unit 194, a scanning unit 195, a printing unit 196, an NETIF 197, the input-output interface 198, an external storage device 199, and an image processing unit 190.

The CPU 191 comprehensively controls the scanning device 102.

The ROM 192 is a memory which stores a program.

The RAM 193 is a memory which temporarily stores a program and image data.

The scanning unit 195 is a scanner and scans an image on an original.

The printing unit 196 prints an image on a sheet based on image data. Furthermore, the printing unit 196 is not essential.

The NETIF 197, which is a network interface, performs control to perform data transfer with external equipment via a network. The image processing unit 190 performs various image editing processing operations on input image data.

While, here, the host computer 101 and the scanning device 102 are configured separately from each other, these can be configured integrally with each other as a single information processing apparatus. Moreover, a scan setting screen and an advanced setting screen each described below are screens to be displayed on the display unit 119. Furthermore, in the first exemplary embodiment, the scanning device 102 is described with an electrophotographic-type digital multifunction peripheral, which has a plurality of functions such as copying, printing, and facsimile (FAX), cited as an example. However, the scanning device 102 is not limited to this, and the first exemplary embodiment is also applicable to, for example, equipment which uses another process such as an inkjet method or a scanner which performs only image scanning. Moreover, the host computer 101 can be a desktop personal computer, a smartphone, or a notebook personal computer.

### [Software Configuration of Scanning System]

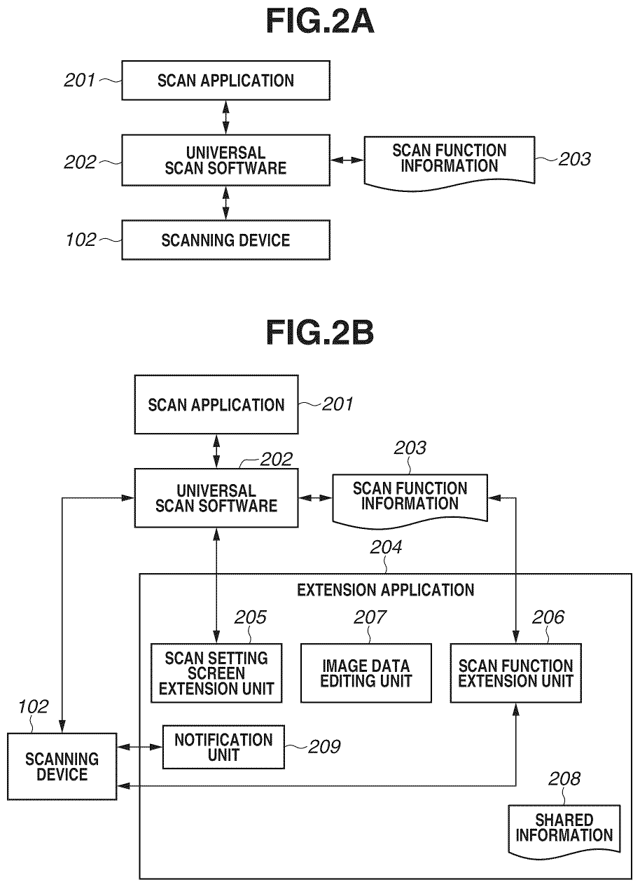

FIGS. 2A and 2B are diagrams each schematically illustrating a software configuration of the scanning system. The software configuration illustrated in FIG. 2A or 2B is stored in the external storage device 114 illustrated in FIG. 1. Here, a scanning system using a host computer 101 loaded with Windows® 11 of Microsoft® serving as an OS is described as a premise. Furthermore, in macOS of Apple, a standard driver is also provided, so that the first exemplary embodiment is also applicable to this.

FIG. 2A is a diagram illustrating a general configuration in a case where an extension application 204 is not associated with universal scan software 202 and the scanning device 102.

FIG. 2B is a diagram illustrating a configuration in a case where the extension application 204 is associated with the universal scan software 202 and the scanning device 102.

[Software Configuration of Scanning System (Extension application Not Being Associated)]

First, a configuration of the scanning system in a case where the extension application 204 is not associated is described with reference to FIG. 2A.

A scan application 201 is software for taking in content (image data) obtained by scanning. For example, a document creation application or an image editing application is equivalent to the scan application 201. Upon receiving a scan request from the user, the scan application 201 issues a scan instruction to the OS. The scan instruction includes scan setting information for issuing an instruction for operations of the universal scan software 202 and the scanning device 102.

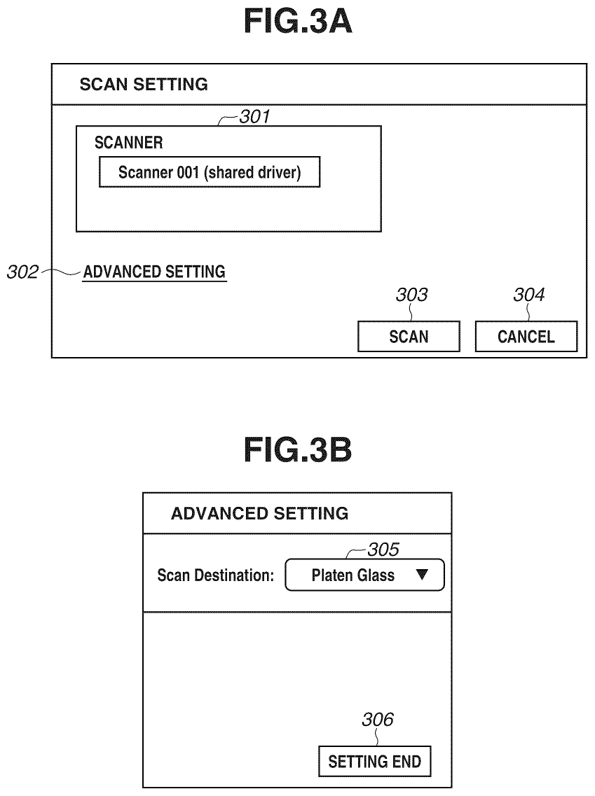

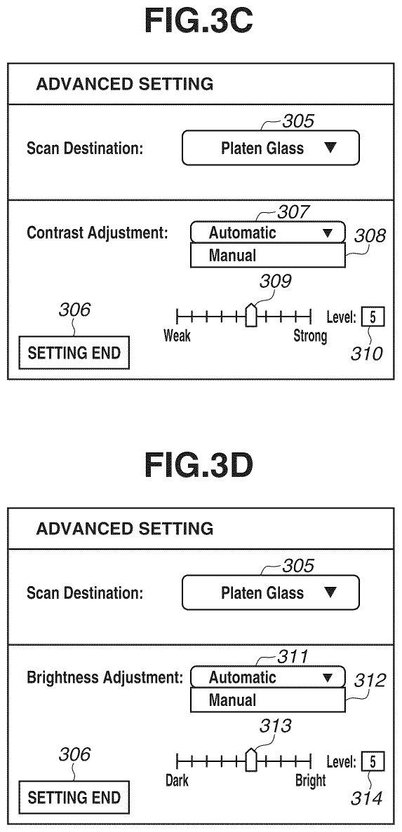

The scan application 201 is able to cause a scan setting screen, which any one of the universal scan software 202, the OS, and the scan application 201 provides, to be displayed to execute the scan instruction. Moreover, in response to an advanced setting button in the scan setting screen being pressed, the universal scan software 202 additionally displays an advanced setting screen. The scan setting screen and the advanced setting screen are described below with reference to FIGS. 3A, 3B, 3C, and 3D. The advanced setting screen includes a setting item (hereinafter referred to as a “control item”) indicating a scan function settable according to scan function information (settable information) 203 about the universal scan software 202 and a setting value for the setting item. The universal scan software 202 determines a scan capability based on the scan function information 203.

The scan function information 203 is data indicating all of the settable scan functions, setting values therefor, and scan functions in which an exclusive relationship between the setting values is described. The scan function information 203 is included in a configuration file of the universal scan software 202, and is arranged as a non-modifiable file in the external storage device 114. Alternatively, the scan function information 203 is able to be dynamically generated by the universal scan software 202. Specifically, the universal scan software 202 or the OS can be configured to acquire scanning device attribute data from the scanning device 102 and generate the scan function information 203 according to attribute information included in the acquired attribute data. Furthermore, in a case where the scan function information 203 is dynamically generated, the generated scan function information 203 is editable. Furthermore, the scanning device attribute data which is acquired from the scanning device 102 includes attribute information indicating a scan function able to be designated by the scanning device 102 (scanning device capability) and a setting value related to the attribute information. Such information is stored in the RAM 113.

As configured in this manner, the universal scan software 202 can be configured to allow the user to designate a scan function which is available in each scanning device 102 according to the connected scanning device 102. In other words, even in a case where a scanning device having a different function or a scanning device developed by a different vendor has been connected, the universal scan software 202 can be configured to allow the user to designate a scan function which is available according to the connected scanning device. Moreover, the universal scan software 202 is able to generate a scan instruction which is interpretable by a plurality of scanning devices manufactured by the respective different vendors and output the generated scan instruction to each of the plurality of scanning devices manufactured by the respective different vendors. Furthermore, the vendor can be a manufacturer (maker) of the scanning device 102. Furthermore, here, the universal scan software 202 is a standard class driver which performs scanning based on a standard scan protocol called “Mopria”. The universal scan software 202 acquires capability information about the connected scanning device 102 and generates scan function information 203 based on the acquired capability information, in such a way as to allow the user to designate a scan function which is supported by the connected scanning device 102. However, the universal scan software 202 is compatible with neither the contrast adjustment function nor the brightness adjustment function. This is because each of the contrast adjustment function and the brightness adjustment function is a function unique to a scanner vendor (scanner manufacturer).

### <Contrast Adjustment Function>

The contrast adjustment function is the function of adjusting contrast of a scanned image. Scanning an original with contrast made strong makes a difference between a bright portion and a dark portion of an image large, thus enabling acquiring clear image data. Scanning an original with contrast made weak makes a difference between a bright portion and a dark portion of an image small, thus enabling acquiring obscure image data.

The contrast adjustment function allows setting of adjustment levels. Moreover, the contrast adjustment function also allows automatic setting and enables automatically acquiring image data with appropriate contrast.

While, in the first exemplary embodiment, an example in which the contrast adjustment function is set within the range of 10 adjustment levels is described, the setting of the contrast adjustment function is not limited to this method. The contrast adjustment function can be set within the broader range or within the narrower range.

### <Brightness Adjustment Function>

The brightness adjustment function is the function of adjusting brightness of a scanned image. Scanning an original with use of the brightness adjustment function enables making the color of the entire image data bright or dark, thus enabling the user to acquire optional image data.

The brightness adjustment function allows setting of adjustment levels as with the contrast adjustment function. Moreover, the brightness adjustment function also allows automatic setting and enables automatically acquiring image data with appropriate brightness.

While, in the first exemplary embodiment, an example in which the brightness adjustment function is set within the range of 10 adjustment levels is described, the setting of the brightness adjustment function is not limited to this method. The brightness adjustment function can be set within the broader range or within the narrower range.

[Software Configuration of Scanning System (Extension application Being Associated)]

Next, a configuration of the scanning system in a case where the extension application 204 is associated is described with reference to FIG. 2B. Furthermore, the same constituent elements as those illustrated in FIG. 2A are omitted from description here.

The extension application 204 is software for extending or supporting the function of the universal scan software 202, and is also called a “support application”. The extension application 204 is software which is not preliminarily included in the OS (is not bundled software). Therefore, the user needs to operate the host computer 101, download the extension application 204 from a server via the Internet, and install the extension application 204 on the host computer 101. Alternatively, the extension application 204 can be automatically installed based on the scanning device 102 having been connected to the host computer 101. Specifically, in a case where the scanning device 102 has been connected to the host computer 101, the OS acquires device identification information from the scanning device 102. The OS can download an extension application 204 corresponding to the acquired device identification information from a server via the Internet and install the extension application 204 on the host computer 101. Thus, the universal scan software 202 and the extension application 204 are retained as respective separate files in the host computer 101.

Furthermore, while the universal scan software 202 and the extension application 204 may be updated to be upgraded in version, this update processing is also performed at respective separate timings. Thus, timing at which the universal scan software 202 is acquired by the host computer 101 and timing at which the extension application 204 is acquired by the host computer 101 differ from each other. Moreover, a trigger with which the universal scan software 202 is acquired by the host computer 101 and a trigger with which the extension application 204 is acquired by the host computer 101 also differ from each other. Furthermore, in a case where the extension application 204 has been installed, the OS associates the extension application 204 with the universal scan software 202 and the scanning device 102.

The extension application 204, which is described in the first exemplary embodiment, includes a scan setting screen extension unit 205, a scan function extension unit 206, an image data editing unit 207, and a notification unit 209. Moreover, the extension application 204 further includes shared information 208, which is accessible in common from each unit. The entity of the shared information 208 is files stored in the external storage device 114 or information stored in the RAM 113. The extension application 204 uses an application programming interface (API) provided by the OS to perform writing or reading of information to or from the shared information 208.

Furthermore, the extension application 204 can end an operation thereof each time processing performed by each unit ends. In that case, the OS launches the extension application 204 each time a request for using each unit is received.

Additionally, the extension application 204 can cancel a processing operation thereof during the time when processing is being performed by each unit. In a case where the processing operation has been cancelled, a job which is being processed is cancelled by the OS.

Upon receiving a scan request from the user, the scan application 201 issues a scan instruction to the OS. Even in the present configuration, as with the configuration illustrated in FIG. 2A, the scan application 201 is able to cause a scan setting screen to be displayed. In the present configuration, an advanced setting screen which the extension application 204 provides is displayed. Specifically, an advanced setting screen which the scan setting screen extension unit 205 included in the extension application 204 provides is displayed. Moreover, the scan setting screen extension unit 205 is able to store advanced settings set by the user in the shared information 208.

The extension application 204 includes the image data editing unit 207. The image data editing unit 207 acquires image data from the scanning device 102 and performs editing on the acquired image data. The image data editing unit 207 acquires advanced setting information from the shared information 208, and performs image editing corresponding to the advanced settings on the image data. The image data editing unit 207 can be configured to acquire image data acquired by the universal scan software 202 and perform image editing corresponding to the advanced settings on the image data.

Moreover, even in the configuration illustrated in FIG. 2B, contrast adjustment or brightness adjustment may not be performed by the user. In that case, as in the configuration illustrated in FIG. 2A, the universal scan software 202 can issue a scan request instruction to the scanning device 102 without via the extension application 204.

The extension application 204 includes the scan function extension unit 206. The scan function extension unit 206 is able to edit scan function information 203 which the universal scan software 202 or the OS has generated. This enables the scan function extension unit 206 to perform addition of a function which the extension application 204 provides. Moreover, the scan function extension unit 206 is able to perform, for example, addition of a function which the scanning device 102 supports but the universal scan software 202 does not support (the contrast adjustment function or the brightness adjustment function) and addition of an exclusive relationship between setting values of the scan function. The OS launches the scan function extension unit 206 at the time when the extension application 204 has been associated with the scanning device 102 and the universal scan software 202 for the first time. Additionally, the OS can launch the scan function extension unit 206 at other timing such as the time of boot of the OS.

Moreover, the extension application 204 includes the notification unit 209. The notification unit 209 is able to display a notification to the user in response to the occurrence of an error in the scanning device 102, which is an image processing device. For example, when a scan jam error occurs in the scanning device 102, the universal scan software 202 detects the occurrence of such an error and the OS causes the display unit 119 to display a message with use of a notification function called “toast notification”, which is a function of the OS. In response to the toast notification being pressed by the user, the notification unit 209 of the extension application 204 is invoked by the OS, so that a user interface (UI) screen of the notification unit 209 is displayed. The UI screen of the notification unit 209 is able to be used to perform, for example, displaying of, for example, a detailed message of the scan jam error or a jam release method.

Moreover, the configuration of the extension application 204 for implementing the first exemplary embodiment is not limited to a configuration including all of the above-mentioned functions (units), but can be a configuration including only some of the functions or a configuration additionally including another function. Moreover, the extension application 204 may be simply called “scan software”.

As described above, the extension application 204 can be said to include at least one of the following functions:
The first is the function of displaying a setting screen (the scan setting screen extension unit 205).
The second is the function of editing image data according to advanced settings (the image data editing unit 207).
The third is the function of extending a function which is able to be designated by image data generation software (the scan function extension unit 206).
The fourth is the function of displaying a screen in response to the occurrence of an error in the scanning device 102 (the notification unit 209).

### <Setting Screen>

Next, examples of the scan setting screen and the advanced setting screen in the first exemplary embodiment are described with reference to FIGS. 3A to 3D.
FIG. 3A illustrates a scan setting screen which is displayed by the scan application 201.
FIG. 3B illustrates an advanced setting screen which is displayed in the case of a configuration in which the extension application 204 is not provided as illustrated in FIG. 2A.
Each of FIGS. 3C and 3D illustrates an advanced setting screen which is displayed in the case of a configuration in which the extension application 204 is provided as illustrated in FIG. 2B.

Furthermore, the unit or module which displays the scan setting screen is not limited to the above-mentioned one.

For example, the scan setting screen extension unit 205 can be configured to only generate a display screen. In that case, the scan setting screen extension unit 205 can transmit the generated display screen to the scan application 201 via the universal scan software 202. The scan application 201 can display the acquired display screen.

### <Scan Setting Screen (Scan Application)>

First, the scan setting screen which is displayed by the scan application 201, illustrated in FIG. 3A, is described.

A control 301 includes respective objects for allowing the user to set a scanner via which to scan image data (a scanner used for scanning).

A control 303 is a scan start button, and a control 304 is a button for cancelling scanning.

A control 302 is an advanced setting button, and, in response to the control 302 being pressed, an additional scan screen is displayed by the universal scan software 202 or the scan setting screen extension unit 205.

### <Advanced Setting Screen (Universal Scan Software)>

Next, FIG. 3B is explained. FIG. 3B illustrates an additional setting screen which is displayed by the universal scan software 202 in a case where the extension application 204 is not provided.

A control 305 is usable to set a scan destination, which, here, indicates that a platen glass is currently selected.

A control 306 is a setting end button, and, in response to the control 306 being pressed, the advanced setting screen returns to the scan setting screen illustrated in FIG. 3A.

### <Scan Setting Screen (Scan Setting Screen Extension Unit)>

### <Contrast Adjustment>

Next, FIG. 3C is explained. FIG. 3C illustrates an additional setting screen for the contrast adjustment function which is displayed by the scan setting screen extension unit 205 in a case where the extension application 204 is provided. Unlike the setting screen illustrated in FIG. 3B, a control 307, a list 308, a control 309, and a control 310 are added.

The control 307 is a button which is usable to select setting of contrast adjustment, which, here, indicates that “automatic” is currently selected.

The list 308 indicates a setting item for contrast adjustment in response to the control 307 being pressed. The list 308 currently indicates that there is “manual” in addition to the currently selected “automatic”. The setting item “automatic” is a setting for automatically performing contrast adjustment, so that contrast adjustment can be automatically performed on an image obtained by scanning. The setting item “manual” is a setting for allowing the user to manually perform contrast adjustment, so that the contrast of an image obtained by scanning can be adjusted by moving the bar of the control 309 in the rightward or leftward direction.

The control 310 indicates the level of contrast which the user has set when selecting “manual” in the list 308. While, in the first exemplary embodiment and subsequent exemplary embodiments, operations which are performed in a case where “automatic” has been selected in the list 308 are described, such exemplary embodiments are also applicable to operations which are performed in a case where “manual” has been selected and the user has set a contrast level.

### <Brightness Adjustment>

Next, FIG. 3D is explained. FIG. 3D illustrates an additional setting screen for the brightness adjustment function which is displayed by the scan setting screen extension unit 205 in a case where the extension application 204 is provided. As with the setting screen illustrated in FIG. 3C, a control 311, a list 312, a control 313, and a control 314 are added. The control 311 is a button which is usable to select setting of brightness adjustment, which, here, indicates that “automatic” is currently selected. The list 312 indicates a setting item for brightness adjustment in response to the control 311 being pressed. The list 312 currently indicates that there is “manual” in addition to the currently selected “automatic”. The setting item “automatic” is a setting for automatically performing brightness adjustment, so that brightness adjustment can be automatically performed on an image obtained by scanning. The setting item “manual” is a setting for allowing the user to manually perform brightness adjustment, so that the brightness of an image obtained by scanning can be adjusted by moving the bar of the control 313 in the rightward or leftward direction. The control 314 indicates the level of brightness which the user has set when selecting “manual” in the list 312.

While, in the first exemplary embodiment and subsequent exemplary embodiments, operations which are performed in a case where “automatic” has been selected in the list 312 are described, such exemplary embodiments are also applicable to operations which are performed in a case where “manual” has been selected and the user has set a brightness level.

While, in the present example, a configuration in which a bar is used for setting at the time of manual adjustment is employed, a method of directly inputting a numerical value or an input method using, for example, a button for selecting a numerical value can also be employed. Moreover, a configuration in which, for example, an icon indicating brightness is displayed to be selected can also be employed.

Here, the reason why the scan setting items differ between the setting screen illustrated in FIG. 3B and the setting screens illustrated in FIGS. 3C and 3D is described.

The advanced setting screen is generated by reference to a scan capability generated based on the scan function information. However, since the universal scan software 202 is compatible with neither the contrast adjustment function nor the brightness adjustment function, it is impossible to add the contrast adjustment function or the brightness adjustment function to the scan function information. Moreover, even if the contrast adjustment function or the brightness adjustment function is originally included in the scan function information, the universal scan software 202 is unable to interpret the contrast adjustment function or the brightness adjustment function included in the scan function information. Therefore, it is impossible to display contrast adjustment setting or brightness adjustment setting in the advanced setting screen. However, a configuration in which the scan function extension unit 206 adds the contrast adjustment function or the brightness adjustment function to the scan function information 203 and a configuration in which the scan setting screen extension unit 205 refers to the scan capability and thus causes the advanced setting screen to be displayed are employed. These configurations enable the extension application 204 to cause contrast adjustment setting or brightness adjustment setting to be displayed in the advanced setting screen. Furthermore, in the setting screens illustrated in FIGS. 3C and 3D, an extended function other than the contrast adjustment function or the brightness adjustment function can be additionally included.

### [Editing Processing of Scan Function Information: Scan Function Extension Unit]

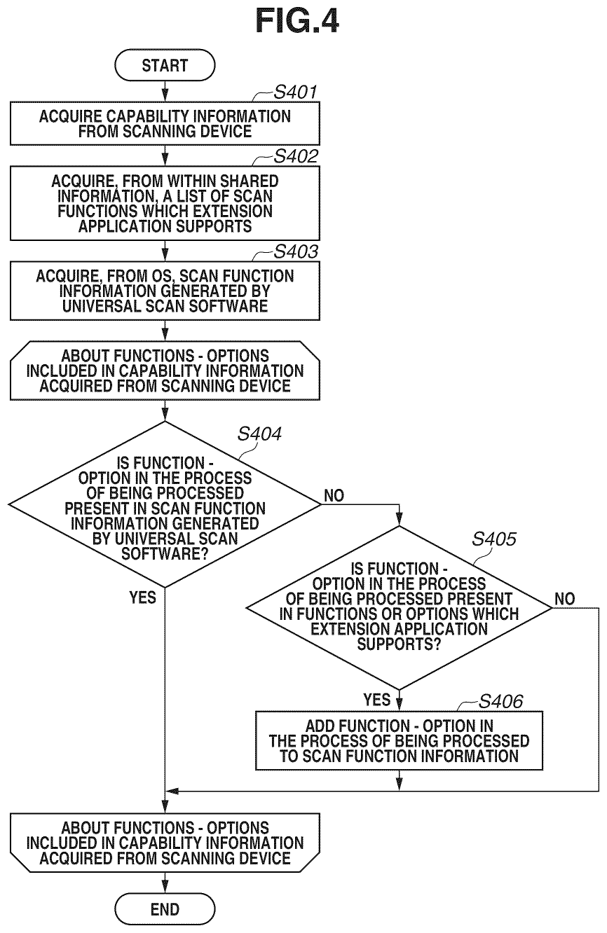

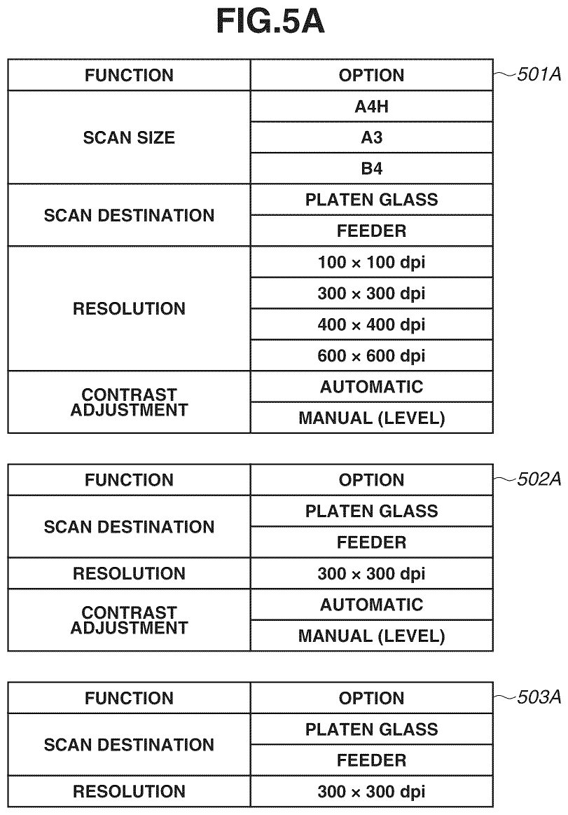

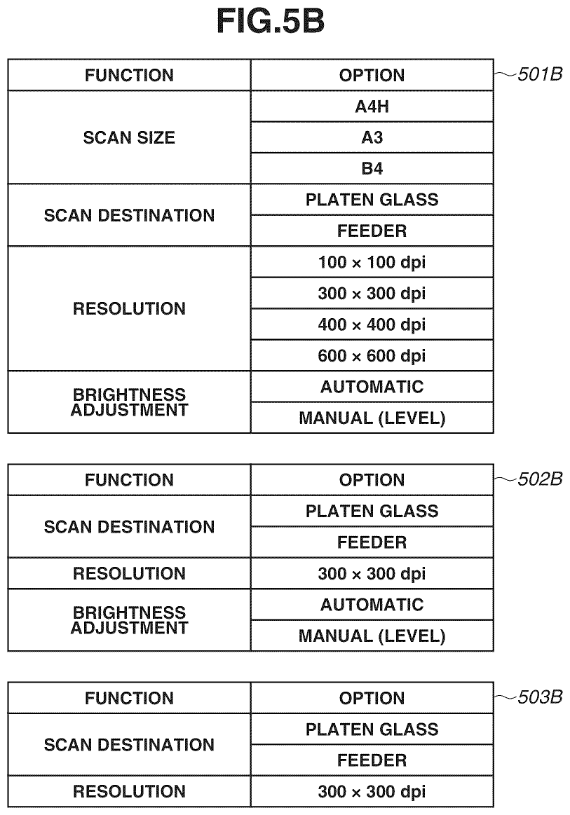

Here, a flowchart of processing which the scan function extension unit 206 performs to edit the scan function information 203 is described with reference to FIG. 4 and FIGS. 5A and 5B. Furthermore, steps in the flowchart are implemented by the CPU 111 reading out the respective units from the external storage device 114 onto the RAM 113 and executing the respective read-out units.

### <Contrast Adjustment Function>

In the first place, the contrast adjustment function is described with reference to FIG. 4 and FIG. 5A.

First, in step S401, the scan function extension unit 206 acquires capability information from the scanning device 102, which is an image processing device. The capability information includes attribute information indicating functions which are able to be designated in the scanning device 102 and setting values related to the attribute information.

A table 501A illustrated in FIG. 5A shows an example of a list of pieces of capability information acquired from the scanning device 102.

As shown in the table 501A illustrated in FIG. 5A, it is possible to acquire, from the scanning device 102, functions such as scan size designation and options which are able to be set with respect to the respective functions.

Next, in step S402, the scan function extension unit 206 acquires, from within the shared information 208, a list of scan functions which the extension application 204 supports. The list of scan functions which the extension application 204 supports is preliminarily stored in the shared information 208, and is a list in which all of the functions which the extension application 204 is able to process and setting values of the respective functions have been written. A table 502A illustrated in FIG. 5A shows an example of a list of scan functions which the extension application 204 supports. The list of scan functions which the extension application 204 supports may be updated by, for example, updating of the extension application 204.

Next, in step S403, the scan function extension unit 206 acquires, from the OS, the scan function information 203 generated by the universal scan software 202. A table 503A illustrated in FIG. 5A shows an example of a list of scan functions which the universal scan software 202 supports. The scan function information 203 which the universal scan software 202 generates is generated based on the capability information (the table 501A illustrated in FIG. 5A) which the universal scan software 202 has acquired from the scanning device 102. Since only the scan functions which the universal scan software 202 supports out of the scan functions acquired from the scanning device 102 are written in the scan function information 203 which the universal scan software 202 generates, the functions written in the scan function information are limitative. For example, while the contrast adjustment function is included in the capability information acquired from the scanning device 102 (the table 501A illustrated in FIG. 5A), the universal scan software 202 does not support the contrast adjustment function and the contrast adjustment function is not written in the scan function information. The scan function extension unit 206 adding a function-option to the scan function information enables the extension application 204 to compensate for the lack of functions of the universal scan software 202. Moreover, the scan function extension unit 206 is able to remove an unnecessary function-option from the scan function information which is generated by the universal scan software 202.

In subsequent steps S404, S405, and S406, processing is repeatedly performed with respect to the list of pieces of capability information acquired from the scanning device 102 in step S401. In the first exemplary embodiment, the processing is repeatedly performed with respect to 11 types of capability information including “scan size: A4H” to “contrast adjustment: manual (level)” included in the table 501A.

First, in step S404, the scan function extension unit 206 determines whether the function-option in the process of being processed is present in the scan function information 203 generated by the universal scan software 202. If it is determined that the function-option in the process of being processed is present in the scan function information 203 (YES in step S404), the scan function extension unit 206 returns the processing to the beginning of the loop processing. Specifically, the scan function extension unit 206 selects a next item from among the functions or options included in the capability information acquired from the scanning device 102 and then performs step S404 again. If the scan function extension unit 206 is in the process of processing the last item from among the functions or options included in the capability information acquired from the scanning device 102, the scan function extension unit 206 exits the loop processing and then ends the processing in the flowchart of FIG. 4. If it is determined that the function-option in the process of being processed is not present in the scan function information 203 (NO in step S404), the scan function extension unit 206 advances the processing to step S405. In the first exemplary embodiment, since, for example, “scan destination: platen glass” shown in the table 501A indicating the scan functions of the scanning device 102 is also present in the table 503A indicating the scan functions of the universal scan software 202, the result of determination in step S404 is YES. On the other hand, since “scan size: A4H” shown in the table 501A is not present in the table 503A, the result of determination in step S404 is NO, so that the scan function extension unit 206 advances the processing to step S405.

Next, in step S405, the scan function extension unit 206 determines whether the function-option in the process of being processed is present in the functions or options which the extension application 204 supports. If it is determined that the function-option in the process of being processed is present (YES in step S405), the scan function extension unit 206 advances the processing to step S406. If it is determined that the function-option in the process of being processed is not present (NO in step S405), as with the case where the result of determination in step S404 is YES, the scan function extension unit 206 performs step S404 again or exits the loop processing to end the processing in the flowchart of FIG. 4. In the first exemplary embodiment, for example, in a case where the function-option in the process of being processed is “contrast adjustment: automatic”, since the function-option in the process of being processed is also present in the table 502A indicating the scan functions of the extension application 204, the result of determination in step S405 is YES, so that the scan function extension unit 206 advances the processing to step S406.

Next, in step S406, the scan function extension unit 206 adds the function-option in the process of being processed to the scan function information 203. After the processing operation in step S406, as with the case where the result of determination in step S404 is YES, the scan function extension unit 206 performs step S404 again or exits the loop processing to end the processing in the flowchart of FIG. 4.

As described above, the scan function extension unit 206 adds, to the scan function information 203, a function-option with which the universal scan software 202 is incompatible, the scanning device 102 is compatible, and the extension application 204 is compatible. Thus, a scan capability is generated based on the scan function information 203 edited by such processing. Additionally, the scan setting screen extension unit 205 generating a display screen based on the generated scan capability enables extending a function with which the universal scan software 202 is incompatible and thus displaying the advanced setting screen illustrated in FIG. 3C.

### <Brightness Adjustment Function>

Next, the case of performing extension to add the brightness adjustment function is described with reference to FIG. 4 and FIG. 5B. Furthermore, only portions different from those in the case of performing extension to add the contrast adjustment function are described. A table 501B illustrated in FIG. 5B shows an example of a list of pieces of capability information acquired from the scanning device 102, which is an image processing device, and a table 502B illustrated in FIG. 5B shows an example of a list of scan functions which the extension application 204 supports. Moreover, a table 503B illustrated in FIG. 5B shows an example of a list of scan functions which the universal scan software 202 supports, and is assumed to be the same as the table 503A illustrated in FIG. 5A. In the following description, only portions different from those illustrated in FIG. 5A are described.

While, in the case of the examples illustrated in FIG. 5B, the brightness adjustment function is included in the capability information acquired from the scanning device 102 (the table 501B illustrated in FIG. 5B), the brightness adjustment function is not supported by the universal scan software 202 shown in the table 503B illustrated in FIG. 5B. Therefore, the scan function extension unit 206 adding the brightness adjustment function to the scan function information 203 makes the brightness adjustment function available. In the following description, the processing operation is specifically described with reference to FIG. 5B.

In the case of the brightness adjustment function illustrated in FIG. 5B, the function “brightness adjustment” shown in the table 501B illustrated in FIG. 5B indicating the capability information about the scanning device 102 is not present in the table 503B indicating the capability information about the universal scan software 202. Therefore, in a case where the function “brightness adjustment” is a function in the process of being processed, the result of determination in step S404 illustrated in FIG. 4 is NO. Then, since the function “brightness adjustment” is present in the table 502B illustrated in FIG. 5B indicating the scan functions of the extension application 204, the result of determination in step S405 is YES. Then, in step S406, the scan function extension unit 206 adds the function “brightness adjustment” to the scan function information 203.

With such processing, additionally, the scan setting screen extension unit 205 generating a display screen based on the scan function information 203 enables extending a function with which the universal scan software 202 is incompatible and thus displaying the advanced setting screen illustrated in FIG. 3D.

### [Sequence of Scan Processing]

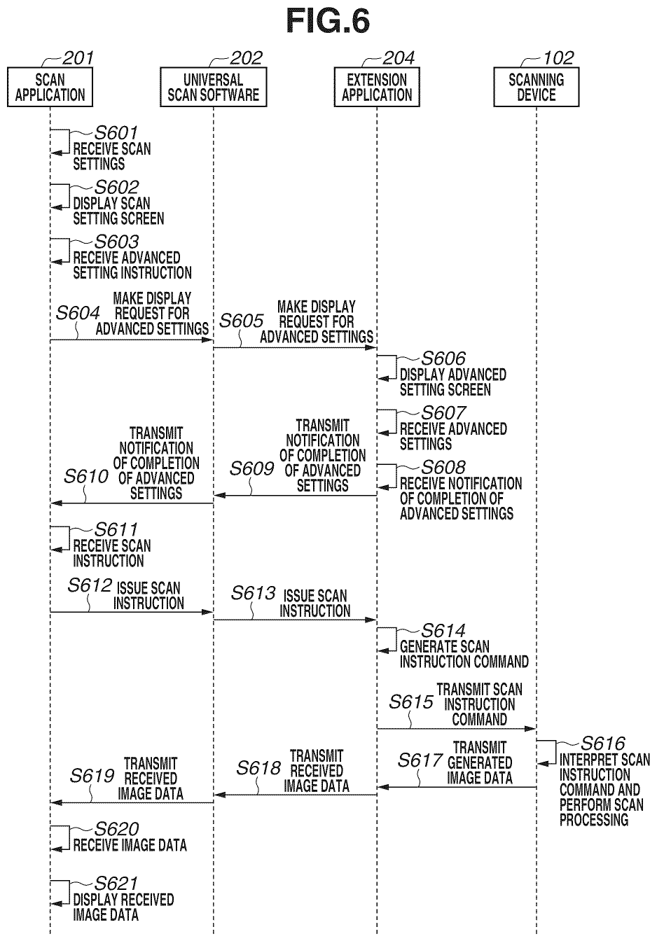

Next, a sequence of operations of the scan application 201, the universal scan software 202, the extension application 204, and the scanning device 102 after the scan application 201 receives scan settings is described with reference to FIG. 6. Furthermore, steps other than a step which is performed by the scanning device 102, illustrated in FIG. 6, are implemented by the CPU 111 reading out the scan application 201, the universal scan software 202, and the extension application 204 from the external storage device 114 onto the RAM 113 and executing them. The step which is performed by the scanning device 102 illustrated in FIG. 6 is implemented by the CPU 191 of the scanning device 102 reading out a program stored in the ROM 192 or the external storage device 199 onto the RAM 193 and executing the program.

In step S601, the scan application 201 receives scan settings performed by the user.

The user can operate the pointing device 117 or the keyboard 118 to issue an instruction for scan settings to the scan application 201.

In step S602, the scan application 201 displays the scan setting screen illustrated in FIG. 3A on the display unit 119.

In step S603, the scan application 201 receives an advanced setting instruction. The user can operate the pointing device 117 or the keyboard 118 to select the control 302, thus issuing an instruction for advanced settings.

In step S604, the scan application 201 makes a display request for advanced settings to the universal scan software 202.

In step S605, the universal scan software 202 makes a display request for advanced settings to the extension application 204. Furthermore, as mentioned above, the extension application 204 comes to display a predetermined advanced setting screen in the configuration illustrated in FIG. 2B. In a case where the contrast adjustment function is currently added (the case of the example illustrated in FIG. 5A), the extension application 204 displays the advanced setting screen illustrated in FIG. 3C, and, in a case where the brightness adjustment function is currently added (the case of the example illustrated in FIG. 5B), the extension application 204 displays the advanced setting screen illustrated in FIG. 3D.

In step S606, the scan setting screen extension unit 205 of the extension application 204 causes the display unit 119 to display the advanced setting screen illustrated in FIG. 3C in the case of the example illustrated in FIG. 5A or the advanced setting screen illustrated in FIG. 3D in the case of the example illustrated in FIG. 5B. This is because, as described above with reference to FIG. 4, the contrast adjustment setting or the brightness adjustment setting has been added to the scan function information 203 by the scan function extension unit 206. The scan setting screen extension unit 205 causes the display unit 119 to display the advanced setting screen illustrated in FIG. 3C or FIG. 3D by reference to the scan capability generated based on the scan function information subjected to addition. In the first exemplary embodiment, since the resolution which the extension application 204 supports is one type, i.e., 300 × 300 dots per inch (dpi), it is not necessary to cause the user to select a resolution, so that any resolution is not displayed in the advanced setting screen. A configuration in which, even if it is impossible to select a resolution, the resolution is displayed in the advanced setting screen to be expressly provided to the user can be employed.

In step S607, the scan setting screen extension unit 205 receives advanced settings. In the case of the example illustrated in FIG. 5A, it is assumed that, as illustrated in FIG. 3C, “scan destination: platen glass” and “contrast adjustment: automatic” have been selected by the user. Moreover, in the case of the example illustrated in FIG. 5B, it is assumed that, as illustrated in FIG. 3D, “scan destination: platen glass” and “brightness adjustment: automatic” have been selected by the user. The received settings are then stored in the RAM 113 by the CPU 111.

In step S608, the scan setting screen extension unit 205 receives a notification indicating completion of advanced settings and issues an instruction for writing the received settings into the scan setting information. The user can operate the pointing device 117 or the keyboard 118 to select the control 306, thus issuing an instruction for completing advanced settings. A configuration in which, in the case of writing into the scan setting information, as with a resolution, an item which the user is not caused to select is also subjected to writing can be employed.

In step S609, the extension application 204 transmits a notification indicating completion of advanced settings to the universal scan software 202.

In step S610, the universal scan software 202 transmits a notification indicating completion of advanced settings to the scan application 201.

In step S611, the scan application 201 receives a scan instruction from the user.

The user can operate the pointing device 117 or the keyboard 118 to select the control 303, thus issuing an instruction for scanning.

In step S612, the scan application 201 issues a scan instruction to the universal scan software 202.

In step S613, the universal scan software 202 issues a scan instruction to the extension application 204.

In step S614, the extension application 204 generates a scan instruction command based on the scan setting information subjected to writing in step S608. A configuration in which, in a case where an item which the user is not caused to select such as a resolution is not written into the scan setting information in step S608, the extension application 204 adds such an item at the time of generation of the scan instruction command in step S614 can be employed. Moreover, a configuration in which the extension application 204 does not add such an item and the scanning device 102 is caused to operate with default values can be employed.

In step S615, the extension application 204 transmits the scan instruction command to the scanning device 102, thus issuing a scan instruction.

In step S616, the scanning device 102 interprets the scan instruction command and thus performs scanning.

At the time of performing scanning, the scanning device 102 performs image processing on image data corresponding to the scan instruction.

In the case of the example illustrated in FIG. 5A and the scan settings illustrated in FIG. 3C have been set, the image processing unit 190 performs contrast adjustment on image data obtained by scanning, as described below.

A configuration in which the scanning unit 195 performs scanning while adjusting contrast can be employed. In any case, image data which has been adjusted to the designated contrast is generated. Thus, the scanning device 102 generates image data adjusted to the designated contrast.

Moreover, in a case where, as another example, the scan functions are as illustrated in FIG. 5B and the scan settings illustrated in FIG. 3D have been set, the image processing unit 190 performs brightness adjustment on image data obtained by scanning, as described below. A configuration in which the scanning unit 195 performs scanning while adjusting brightness can be employed. In any case, image data which has been adjusted to the designated brightness is generated. Thus, the scanning device 102 generates image data adjusted to the designated brightness.

In step S617, the scanning device 102 transmits the generated image data to the extension application 204.

In step S618, the extension application 204 transmits the received image data to the universal scan software 202.

In step S619, the universal scan software 202 transmits the received image data to the scan application 201.

In step S620, the scan application 201 receives the image data.

In step S621, the scan application 201 performs displaying of the received image data, and then ends the present processing.

### <Scan Processing: Extension Application>

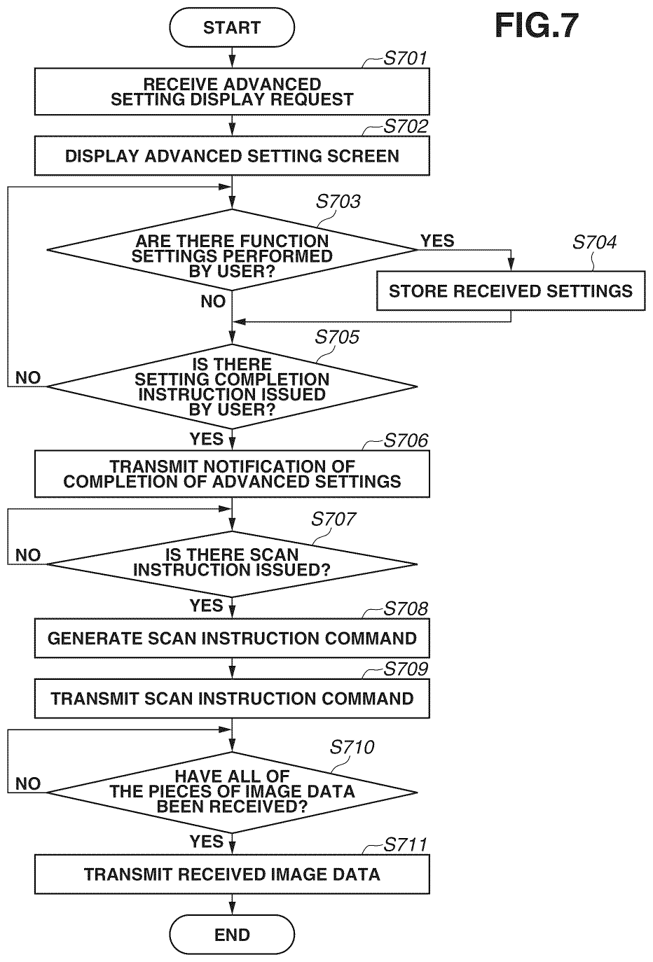

Here, a flowchart of processing which the extension application 204 performs to perform scan processing is described with reference to FIG. 7. Furthermore, steps in the flowchart are implemented by the CPU 111 reading out the respective units from the external storage device 114 onto the RAM 113 and executing the respective read-out units.

In step S701, the extension application 204 receives an advanced setting display request.

In step S702, in the case of the example illustrated in FIG. 5A, the scan setting screen extension unit 205 of the extension application 204 causes the display unit 119 to display the advanced setting screen illustrated in FIG. 3C (or FIG. 3D in a case where, as another example, the scan functions are as illustrated in FIG. 5B). This is because, as described with reference to FIG. 4, in the case of the example illustrated in FIG. 5A, the contrast adjustment setting (or in a case where, as another example, the scan functions are as illustrated in FIG. 5B, the brightness adjustment setting) is added to the scan function information 203 by the scan function extension unit 206. By referring to the scan capability generated based on the scan function information subjected to addition, the scan setting screen extension unit 205 causes the display unit 119 to display the advanced setting screen illustrated in FIG. 3C in the case of the example illustrated in FIG. 5A (or FIG. 3D in a case where, as another example, the scan functions are as illustrated in FIG. 5B).

In step S703, the scan setting screen extension unit 205 determines whether there are function settings performed by the user. If it is determined that there are function settings performed by the user (YES in step S703), the CPU 111 advances the processing to step S704, and, if it is determined that there are no function settings performed by the user (NO in step S703), the CPU 111 advances the processing to step S705.

In step S704, the CPU 111 receives advanced settings, stores the received settings in the RAM 113, and then advances the processing to step S705.

In step S705, the scan setting screen extension unit 205 determines whether there is a setting completion instruction issued by the user. If it is determined that there is a setting completion instruction (YES in step S705), the CPU 111 receives a notification of completion of advanced settings, writes the received settings into the scan setting information, and then advances the processing to step S706. If it is determined that there is no setting completion instruction (NO in step S705), the CPU 111 returns the processing to step S703, in which the scan setting screen extension unit 205 determines again whether there are function settings performed by the user.

In step S706, the extension application 204 transmits a notification of completion of the advanced settings to the universal scan software 202.

In step S707, the extension application 204 determines whether there is a scan instruction issued from the universal scan software 202. If it is determined that there is a scan instruction (YES in step S707), the CPU 111 advances the processing to step S708, and, if it is determined that there is no scan instruction (NO in step S707), the CPU 111 returns the processing to step S707, in which the extension application 204 determines again whether there is a scan instruction issued from the universal scan software 202.

In step S708, the extension application 204 generates a scan instruction command based on the scan setting information subjected to writing in step S705.

The method of generating a scan instruction command in step S708 includes, first, a method of extending a command defined in the standard protocol. The method of extension includes, for example, a method of writing a dedicated command into the extension region of the command defined in the standard protocol. Additionally, the method of extension includes, for example, a method of adding an original standard command to the tail end of the command defined in the standard protocol and a method in which the extension application 204 overwrites the command defined in the standard protocol with an original command system.

Moreover, a configuration in which, when issuing an instruction, the extension application 204 performs an instruction and communication with a vendor-specific protocol irrespective of the standard protocol can be employed.

In step S709, the extension application 204 transmits the scan instruction command to the scanning device 102, thus issuing a scan instruction.

In step S710, the extension application 204 determines whether all of the pieces of image data have been received from the scanning device 102. If it is determined that all of the pieces of image data have been received (YES in step S710), the CPU 111 advances the processing to step S711, and, if not so (NO in step S710), the CPU 111 returns the processing to step S710, in which the extension application 204 determines whether all of the pieces of image data have been received from the scanning device 102. In step S711, the extension application 204 transmits the received image data to the universal scan software 202, and then ends the present processing.

### <Scan Processing: Scanning Device>

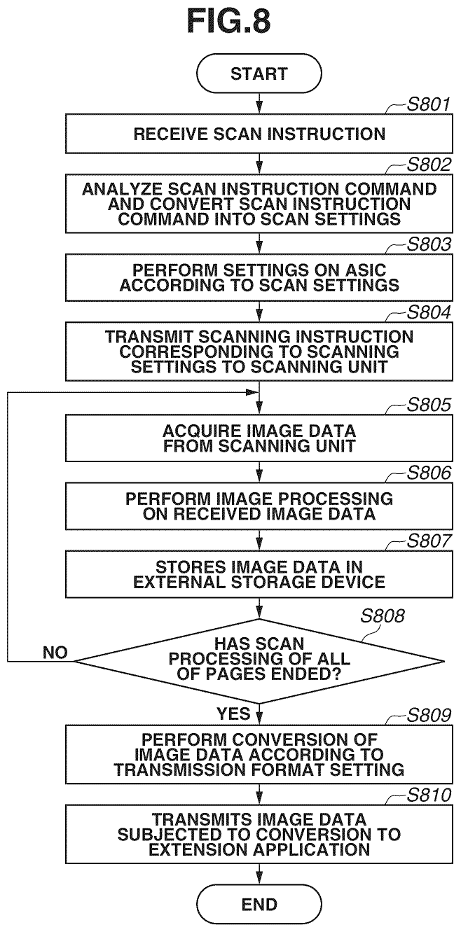

Next, a flowchart of scan processing which the scanning device 102 performs upon receiving a scan instruction from the extension application 204 is described with reference to FIG. 8. Furthermore, steps illustrated in the flowchart of FIG. 8 are implemented by the CPU 191 executing a program stored in the ROM 192.

In step S801, the CPU 191 receives the scan instruction transmitted from the extension application 204.

In step S802, the CPU 191 analyzes the scan instruction command received in step S801, and converts the scan instruction command into scan settings with which the scanning device 102 is able to perform scan processing. In the first exemplary embodiment, in the case of the example illustrated in FIG. 5A, the CPU 191 performs scan settings with contrast adjustment at the platen glass: automatic and resolution: 300×300 dpi, and, in the case of the example illustrated in FIG. 5B, the CPU 191 performs scan settings with brightness adjustment at the platen glass: automatic and resolution: 300×300 dpi.

In step S803, the CPU 191 determines an application specific integrated circuit (ASIC) of the image processing unit 190 which is to be used for performing scanning, according to the scan settings obtained by conversion in step S802, and performs settings on the determined ASIC.

In step S804, the CPU 191 transmits a scanning instruction corresponding to the scanning settings to the scanning unit 195. In the first exemplary embodiment, the CPU 191 transmits an instruction in such a way as to perform scanning at the platen glass.

In step S805, the CPU 191 acquires image data from the scanning unit 195.

In step S806, the CPU 191 and the image processing unit 190 perform image processing on the received image data.

In the case of the example illustrated in FIG. 5A, the CPU 191 performs conversion with resolution: 300×300 dpi and contrast adjustment. In contrast adjustment, the CPU 191 analyzes image data with use of the ASIC set in step S803 and automatically performs adjustment to appropriate contrast. A configuration in which, if the scanning unit 195 is capable of performing scanning with 300×300 dpi, the scanning unit 195 acquires image data with 300×300 dpi and the CPU 191 and the image processing unit 190 do not perform image processing in step S806 can be employed. While, in the first exemplary embodiment, the image processing unit 190 performs contrast adjustment, a configuration in which the scanning unit 195 performs a scanning operation while adjusting contrast can be employed.

Moreover, in the case of the example illustrated in FIG. 5B, the CPU 191 performs conversion with resolution: 300×300 dpi and brightness adjustment. In brightness adjustment, the CPU 191 analyzes image data with use of the ASIC set in step S803 and automatically performs adjustment to appropriate brightness. A configuration in which, if the scanning unit 195 is capable of performing scanning with 300×300 dpi, the scanning unit 195 acquires image data with 300×300 dpi and the CPU 191 and the image processing unit 190 do not perform image processing in step S806 can be employed. While, in the first exemplary embodiment, the image processing unit 190 performs brightness adjustment, a configuration in which the scanning unit 195 performs a scanning operation while adjusting brightness can be employed.

In step S807, the CPU 191 stores the image data in the external storage device 199.

In step S808, the CPU 191 determines whether scan processing of all of the pages has ended. If it is determined that scan processing of all of the pages has not yet ended (NO in step S808), the CPU 191 returns the processing to step S805, in which the CPU 191 performs scan processing of the next page. If it is determined that scan processing of all of the pages has ended (YES in step S808), the CPU 191 advances the processing to step S809.

In step S809, the CPU 191 and the image processing unit 190 perform conversion of the image data previously stored in step S807 according to the transmission format setting previously received in step S801. In the first exemplary embodiment, since the transmission format is not included in the scan instruction received from the extension application 204, it is assumed that the CPU 191 and the image processing unit 190 perform conversion according to Joint Photographic Experts Group (JPEG), which is a default in the scanning device 102. However, the transmission format to be used for conversion is not limited to this, but can be any one of formats capable of being handled by an information processing apparatus.

In step S810, the CPU 191 transmits the image data subjected to conversion to the extension application 204, and then ends the present processing.

As described above, in the first exemplary embodiment, the scan setting screen extension unit 205 of the extension application 204 modifies the scan function information 203 based on respective pieces of capability information about the universal scan software 202, the extension application 204, and the scanning device 102. Additionally, when requested to display the advanced setting screen from the user, the scan setting screen extension unit 205 performs displaying of the setting screen based on the scan capability generated from the scan function information 203, thus allowing the user to perform contrast adjustment or brightness adjustment. After that, upon receiving a scan instruction having contrast adjustment or brightness adjustment reflected therein, the scanning device 102 performs scanning of an original with the designated contrast or brightness. The above-described series of processing operations enables the scanning device 102 to implement the contrast adjustment function or the brightness adjustment function, thus enabling providing the contrast adjustment function or the brightness adjustment function to the user.

Furthermore, naturally, it is possible to make both the contrast adjustment function and the brightness adjustment function implementable.

Moreover, while a configuration in which a scan instruction to the extension application 204 is issued from the universal scan software 202 is employed, the first exemplary embodiment is not limited to this configuration. For example, a method in which the scan instruction is issued from the scan application 201 to the extension application 204 or a configuration in which a control for the scan instruction is arranged in the advanced setting screen and the user directly issues the scan instruction to the extension application 204 can be employed. Moreover, the method of passing image data can be a method of directly passing image data from the extension application 204 to the scan application 201 without via the universal scan software 202 or a method of passing image data from the scanning device 102 to the scan application 201. Moreover, the method of passing image data can be a method of storing received image data in the external storage device 114 and passing only information about a file path serving as a storage location.

Moreover, while, in the first exemplary embodiment, a method in which, in a case where there is a plurality of pieces of image data, passing of image data is performed after all of the pieces of image data have been received is employed, a configuration in which respective pieces of image data are passed as needed can be employed.

Next, a second exemplary embodiment of the present disclosure is described. In the above-described first exemplary embodiment, first, the scanning device 102 interprets scan setting information including contrast adjustment or brightness adjustment, and the scanning device 102 performs scan processing with the contrast adjustment setting or brightness adjustment setting designated by the side of the scanning device 102.

However, some scanning devices may be unable to perform contrast adjustment or brightness adjustment. In that case, even if the extension application supports contrast adjustment or brightness adjustment and scan setting information has been able to be generated with the inclusion of contrast adjustment or brightness adjustment, it is impossible to cause the scanning device to perform adjustment processing for contrast or brightness.

Therefore, in the second exemplary embodiment, first, an information processing apparatus determines whether it is possible to perform contrast adjustment or brightness adjustment, based on capability information about a scanning device. Next, if it is possible to perform contrast adjustment or brightness adjustment in the scanning device, the information processing apparatus generates scan setting information including contrast adjustment setting or brightness adjustment setting designated by the user, and passes the generated scan setting information to the scanning device. On the other hand, if it is impossible to perform contrast adjustment or brightness adjustment in the scanning device, the information processing apparatus generates scan setting information without the inclusion of contrast adjustment setting or brightness adjustment setting, and passes the generated scan setting information to the scanning device. After that, the information processing apparatus causes an extension application to perform contrast adjustment or brightness adjustment on image data obtained by scanning performed by the scanning device. This enables, even in a case where it is impossible to perform contrast adjustment or brightness adjustment in the scanning device, providing image data adjusted to optional contrast or brightness to the user.

Furthermore, in the following description, only differences from those in the first exemplary embodiment are described.

### <In a Case Where Scanning Device Does Not Have Contrast Adjustment Function>

First, the second exemplary embodiment is described with respect to a case where the scanning device 102 does not support the contrast adjustment function.

The extension application 204 in the second exemplary embodiment differs in configuration from the extension application 204 in the first exemplary embodiment. If a unit for performing contrast adjustment processing of image data is included in the extension application 204, the scan function extension unit 206 adds a contrast adjustment designation to the scan function information 203. Thus, even in a case where contrast adjustment is not included in the capability information acquired from the scanning device 102, a contrast adjustment designation is added to the scan function information 203, so that it becomes possible to use the contrast adjustment function. The image data editing unit 207 performs contrast adjustment processing of image data on the image data received from the scanning device 102 based on contrast setting of the contrast adjustment designation function set by the user. The details thereof are described below.

### <Editing Processing of Scan Function Information: Scan Function Extension Unit>

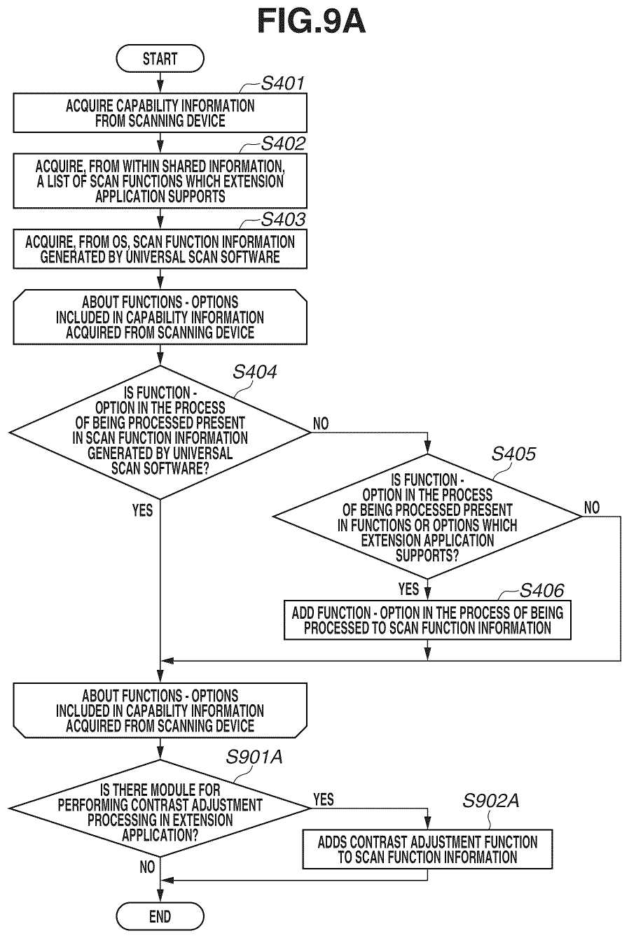

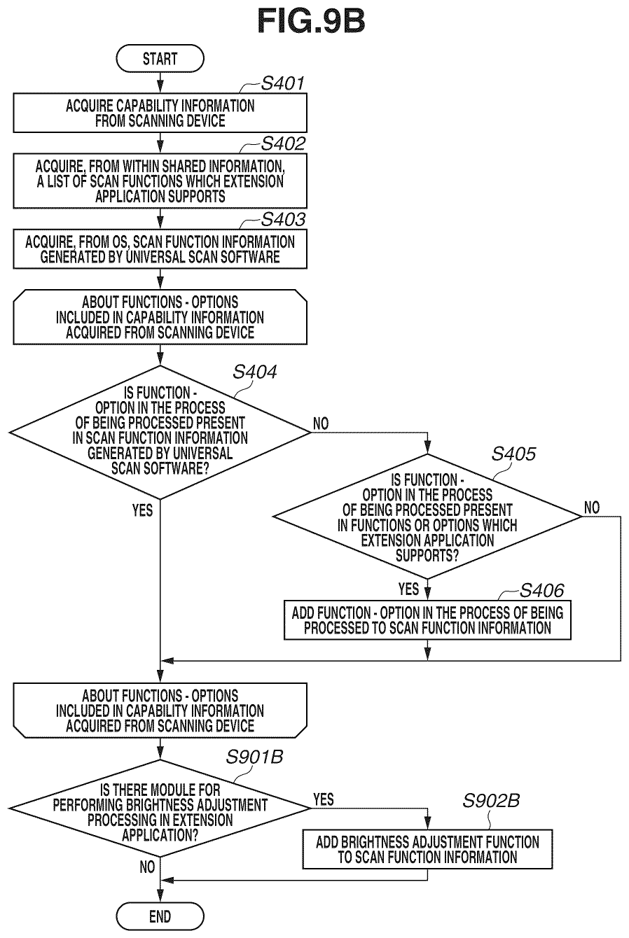

Editing processing of scan function information which the scan function extension unit 206 in the second exemplary embodiment performs is described with reference to FIG. 9A. Steps in common with those illustrated in FIG. 4 are assigned the respective same step numbers as those illustrated in FIG. 4 and are omitted from description here, and differences therebetween are mainly described. Furthermore, steps in the flowchart of FIG. 9A are implemented by the CPU 111 reading out the respective units from the external storage device 114 onto the RAM 113 and executing the respective read-out units.

After repetitive processing operations in steps S404 to S406 has ended, the scan function extension unit 206 advances the processing to step S901A. Here, the scanning device 102 does not support the contrast adjustment function. Therefore, the contrast adjustment function is still not added to the scan function information 203 subjected to the processing operations in steps S404 to S406.

Thus, in steps S901A and S902A, the scan function extension unit 206 performs processing for adding a function to the scan function information 203 according to a module which is not included in the capability information received from the scanning device 102 but is included in the extension application 204.

Specifically, in step S901A, the scan function extension unit 206 refers to the capability information about the scanning device 102 (the table 501A illustrated in FIG. 5A) and the scan function information 203 and determines whether there is a module for performing contrast adjustment processing in the extension application 204. If it is determined that there is a module for performing contrast adjustment processing (YES in step S901A), the scan function extension unit 206 advances the processing to step S902A, and, if it is determined that there is no module for performing contrast adjustment processing (NO in step S901A), the scan function extension unit 206 ends the present processing. In the second exemplary embodiment, since the image data editing unit 207 of the extension application 204 is able to perform contrast adjustment processing, it is determined that there is a module for performing contrast adjustment processing in the extension application 204.

In step S902A, the scan function extension unit 206 adds the contrast adjustment function to the scan function information 203, and then ends the present processing.

As described above, first, the scan function extension unit 206 adds, to the scan function information 203, a function-option with which the universal scan software 202 is incompatible, the scanning device 102 is compatible, and the extension application 204 is compatible. After that, the scan function extension unit 206 determines whether the extension application 204 is able to perform processing for contrast adjustment, and, if it is determined that the extension application 204 is able to perform processing for contrast adjustment, the scan function extension unit 206 adds the contrast adjustment function to the scan function information 203. With this processing, even in a case where the contrast adjustment function is not supported by the scanning device 102, the scan setting screen extension unit 205 generating a display screen based on the scan function information 203 enables displaying the advanced setting screen illustrated in FIG. 3C.

### <In a Case Where Scanning Device Does Not Have Brightness Adjustment Function>

First, the second exemplary embodiment is described with respect to a case where the scanning device 102 does not support the brightness adjustment function.

The extension application 204 in the second exemplary embodiment differs in configuration from the extension application 204 in the first exemplary embodiment. If a unit for performing brightness adjustment processing of image data is included in the extension application 204, the scan function extension unit 206 adds a brightness adjustment designation to the scan function information 203. Thus, even in a case where brightness adjustment is not included in the capability information acquired from the scanning device 102, a brightness adjustment designation is added to the scan function information 203, so that it becomes possible to use the brightness adjustment function. The image data editing unit 207 performs brightness adjustment processing of image data on the image data received from the scanning device 102 based on brightness setting of the brightness adjustment designation function set by the user. The details thereof are described below.

### <Editing Processing of Scan Function Information: Scan Function Extension Unit>

Editing processing of scan function information which the scan function extension unit 206 in the second exemplary embodiment performs is described with reference to FIG. 9B. Steps in common with those illustrated in FIG. 4 are assigned the respective same step numbers as those illustrated in FIG. 4 and are omitted from description here, and difference therebetween are mainly described. Furthermore, steps in the flowchart of FIG. 9B are implemented by the CPU 111 reading out the respective units from the external storage device 114 onto the RAM 113 and executing the respective read-out units.

After repetitive processing operations in steps S404 to S406 has ended, the scan function extension unit 206 advances the processing to step S901B. Here, the scanning device 102 does not support the brightness adjustment function. Therefore, the brightness adjustment function is still not added to the scan function information 203 subjected to the processing operations in steps S404 to S406.

Thus, in steps S901B and S902B, the scan function extension unit 206 performs processing for adding a function to the scan function information 203 according to a module which is not included in the capability information received from the scanning device 102 but is included in the extension application 204.

Specifically, in step S901B, the scan function extension unit 206 refers to the capability information about the scanning device 102 (the table 501B illustrated in FIG. 5B) and the scan function information 203 and determines whether there is a module for performing brightness adjustment processing in the extension application 204. If it is determined that there is a module for performing brightness adjustment processing (YES in step S901B), the scan function extension unit 206 advances the processing to step S902B, and, if it is determined that there is no module for performing brightness adjustment processing (NO in step S901B), the scan function extension unit 206 ends the present processing. In the second exemplary embodiment, since the image data editing unit 207 included in the extension application 204 is able to perform brightness adjustment processing, it is determined that there is a module for performing brightness adjustment processing in the extension application 204.

In step S902B, the scan function extension unit 206 adds the brightness adjustment function to the scan function information 203, and then ends the present processing.

As described above, first, the scan function extension unit 206 adds, to the scan function information 203, a function-option with which the universal scan software 202 is incompatible, the scanning device 102 is compatible, and the extension application 204 is compatible. After that, the scan function extension unit 206 determines whether the extension application 204 is able to perform processing for brightness adjustment, and, if it is determined that the extension application 204 is able to perform processing for brightness adjustment, the scan function extension unit 206 adds the brightness adjustment function to the scan function information 203. With this processing, even in a case where the brightness adjustment function is not supported by the scanning device 102, the scan setting screen extension unit 205 generating a display screen based on the scan function information 203 enables displaying the advanced setting screen illustrated in FIG. 3D.

### [Sequence of Scan Processing]

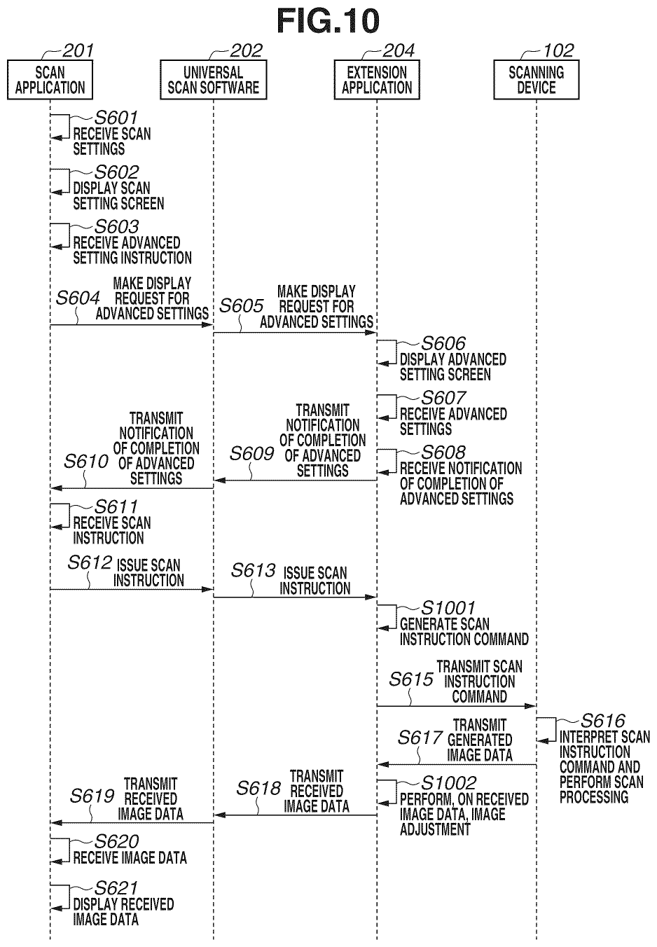

Next, a sequence of operations of the scan application 201, the universal scan software 202, the extension application 204, and the scanning device 102 after the scan application 201 receives scan settings is described with reference to FIG. 10. Furthermore, steps other than a step which is performed by the scanning device 102, illustrated in FIG. 10, are implemented by the CPU 111 reading out the scan application 201, the universal scan software 202, and the extension application 204 from the external storage device 114 onto the RAM 113 and executing them. The step which is performed by the scanning device 102 illustrated in FIG. 10 is implemented by the CPU 191 of the scanning device 102 reading out a program stored in the ROM 192 or the external storage device 199 onto the RAM 193 and executing the program. In the following description, steps in common with those illustrated in FIG. 6 are assigned the respective same step numbers as those illustrated in FIG. 6 and are omitted from description here, and differences therebetween are mainly described.

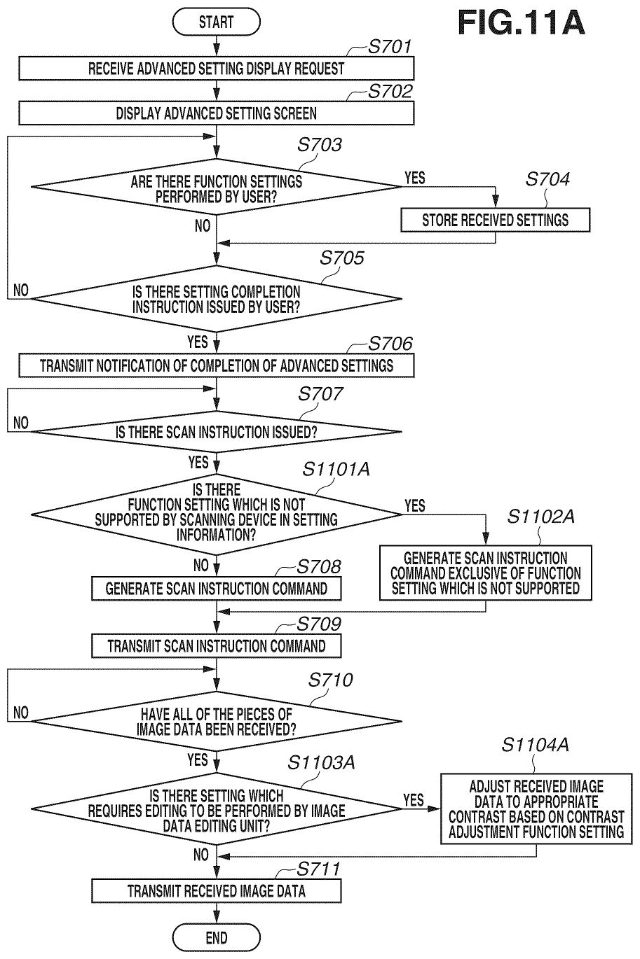

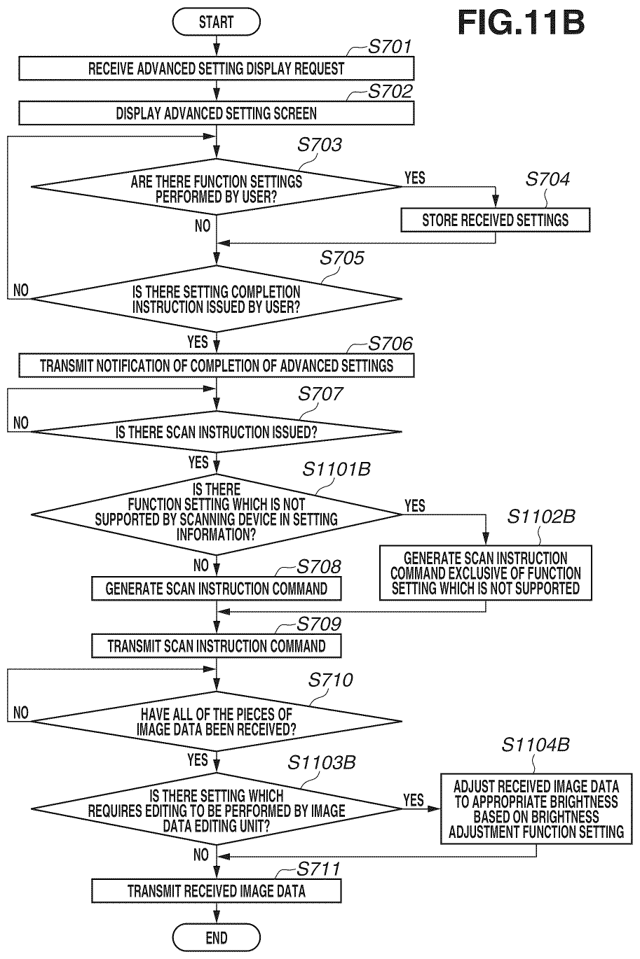

In step S1001, the extension application 204 generates a scan instruction command. The detailed operation thereof performed at this time is described below with reference to the flowcharts of FIGS. 11A and 11B.

In step S1002, the image data editing unit 207 performs, on the received image data, contrast adjustment in the case of the example illustrated in FIG. 5A and brightness adjustment in the case of the example illustrated in FIG. 5B. In the second exemplary embodiment, the information processing apparatus automatically adjusts image data to appropriate contrast or appropriate brightness.

Here, flowcharts of processing which the extension application 204 performs to perform scan processing are described with reference to FIGS. 11A and 11B. steps in common with those illustrated in FIG. 7 are assigned the respective same step numbers as those illustrated in FIG. 7 and are omitted from description here, and differences therebetween are mainly described. Furthermore, steps in the flowcharts are implemented by the CPU 111 reading out the respective units from the external storage device 114 onto the RAM 113 and executing the respective read-out units.

### <Scan Processing: Extension Application>

### <Contrast Adjustment: FIG. 11A>

In step S1101A, the extension application 204 acquires scan function information about the scanning device 102 from the shared information 208. Furthermore, if there is no scan function information about the scanning device 102, the scan function extension unit 206 can request scan function information from the scanning device 102 and then store the received scan function information in the shared information 208.

Then, the extension application 204 determines whether there is a function setting which is not supported by the scanning device 102, based on the acquired scan function information and the setting information. If it is determined that a function which is not supported by the scanning device 102 is currently set (YES in step S1101A), the CPU 111 advances the processing to step S1102A. In the second exemplary embodiment, since an image adjustment function which is not supported by the scanning device 102 (the contrast adjustment function in the case of the example illustrated in FIG. 5A) is currently set, the CPU 111 advances the processing to step S1102A. If it is determined that a function which is not supported by the scanning device 102 is not currently set (NO in step S1101A), the CPU 111 advances the processing to step S708.

Next, in step S1102A, the extension application 204 generates a scan instruction command exclusive of the function setting which is not supported. In the second exemplary embodiment, as a result, the contrast adjustment function or the brightness adjustment function is not included in the scan instruction command.

Next, a subsequent processing operation which is performed in a case where, in step S710, it is determined that all of the pieces of image data have been received (YES in step S710) is described.

In step S1103A, the extension application 204 determines whether there is a setting which requires editing to be performed by the image data editing unit 207, based on the setting information. If it is determined that there is a setting which requires editing (YES in step S1103A), the CPU 111 advances the processing to step S1104A. In the second exemplary embodiment, since the image adjustment function which the scanning device 102 is not able to effect (the contrast adjustment function in the case of the example illustrated in FIG. 5A) is currently set, the CPU 111 advances the processing to step S1104A. On the other hand, if it is determined that there is no setting which requires editing (NO in step S1103A), the CPU 111 advances the processing to step S711.

In step S1104A, the image data editing unit 207 automatically adjusts the received image data to appropriate contrast based on the contrast adjustment function setting set in step S703, and then advances the processing to step S711.

### <Brightness Adjustment: FIG. 11B>

In step S1101B, the extension application 204 acquires scan function information about the scanning device 102 from the shared information 208. Furthermore, if there is no scan function information about the scanning device 102, the scan function extension unit 206 can request scan function information from the scanning device 102 and then store the received scan function information in the shared information 208.

Then, the extension application 204 determines whether there is a function setting which is not supported by the scanning device 102, based on the acquired scan function information and the setting information. If it is determined that a function which is not supported by the scanning device 102 is currently set (YES in step S1101B), the CPU 111 advances the processing to step S1102B. In the second exemplary embodiment, since an image adjustment function which is not supported by the scanning device 102 (the brightness adjustment function in the case of the example illustrated in FIG. 5B) is currently set, the CPU 111 advances the processing to step S1102B. If it is determined that a function which is not supported by the scanning device 102 is not currently set (NO in step S1101B), the CPU 111 advances the processing to step S708.

Next, in step S1102B, the extension application 204 generates a scan instruction command exclusive of the function setting which is not supported. In the second exemplary embodiment, as a result, the contrast adjustment function or the brightness adjustment function is not included in the scan instruction command.

Next, a subsequent processing operation which is performed in a case where, in step S710, it is determined that all of the pieces of image data have been received (YES in step S710) is described.

In step S1103B, the extension application 204 determines whether there is a setting which requires editing to be performed by the image data editing unit 207, based on the setting information. If it is determined that there is a setting which requires editing (YES in step S1103B), the CPU 111 advances the processing to step S1104B. In the second exemplary embodiment, since the image adjustment function which the scanning device 102 is not able to effect (the brightness adjustment function in the case of the example illustrated in FIG. 5B) is currently set, the CPU 111 advances the processing to step S1104B. On the other hand, if it is determined that there is no setting which requires editing (NO in step S1103B), the CPU 111 advances the processing to step S711.

In step S1104B, the image data editing unit 207 automatically adjusts the received image data to appropriate brightness based on the brightness adjustment function setting set in step S703, and then advances the processing to step S711.

In the second exemplary embodiment, the information processing apparatus excludes a function setting which is not supported by the scanning device from the scan instruction command. However, even if a function is written in the scan instruction command, the scanning device is unable to interpret an instruction command which is not supported by the scanning device, and is thus unable to execute the function.

Therefore, without excluding a function setting which is not supported by the scanning device from the scan instruction command, the information processing apparatus can be configured to directly write the function in the scan instruction command.

As described above, in the second exemplary embodiment, even in a case where an image adjustment function (the contrast adjustment function or the brightness adjustment function) is not supported by the scanning device, it becomes possible to provide the image adjustment function to the user.

Next, a third exemplary embodiment of the present disclosure is described. In the above-described first and second exemplary embodiments, a configuration in which the extension application 204 and the scanning device 102 communicate with each other has been described.

In the third exemplary embodiment, a configuration in which a unit which communicates with the scanning device 102 is only the universal scan software 202 and the extension application 204 performs only extension of a scan command or image editing is described.

Furthermore, in the following description, only differences from those in the first and second exemplary embodiments are described.

### [Sequence of Scan Processing (Extension of Command)]

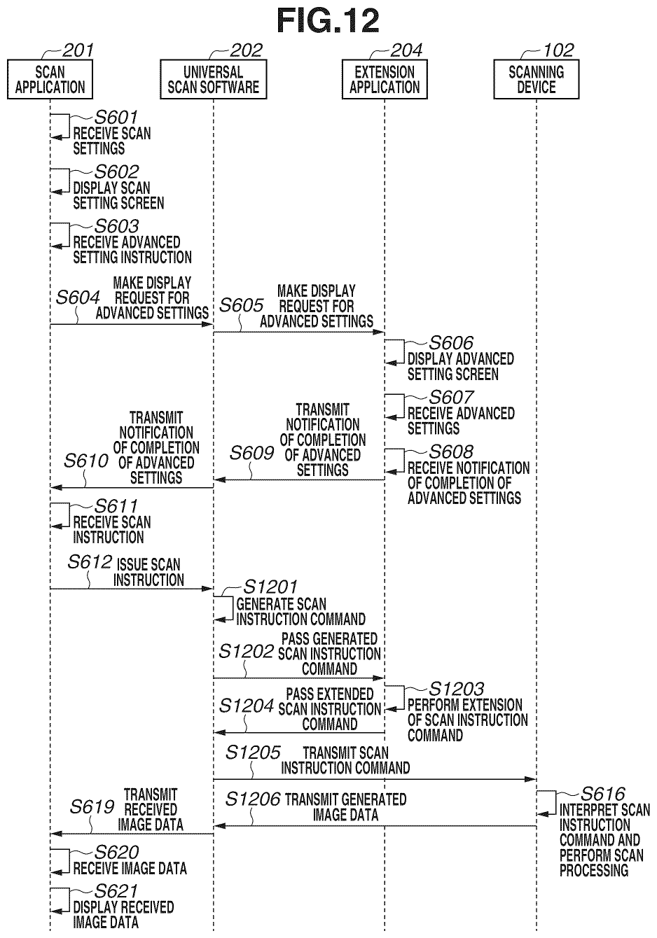

A sequence of operations of the scan application 201, the universal scan software 202, the extension application 204, and the scanning device 102 after the scan application 201 receives scan settings is described with reference to FIG. 12. Steps in common with those illustrated in FIG. 6 are assigned the respective same step numbers as those illustrated in FIG. 6 and are omitted from description here, and differences therebetween are mainly described. Furthermore, steps other than a step which is performed by the scanning device 102, illustrated in FIG. 12, are implemented by the CPU 111 reading out the scan application 201, the universal scan software 202, and the extension application 204 from the external storage device 114 onto the RAM 113 and executing them. The step which is performed by the scanning device 102 illustrated in FIG. 12 is implemented by the CPU 191 of the scanning device 102 reading out a program stored in the ROM 192 or the external storage device 199 onto the RAM 193 and executing the program.

In step S1201, the universal scan software 202 generates a scan instruction command. In this instance, a function which is not supported by the universal scan software 202 is not written into the scan instruction command.

In step S1202, the universal scan software 202 passes the generated scan instruction command to the extension application 204.

In step S1203, the extension application 204 performs additional writing of an instruction command for the function which is not supported by the universal scan software 202 into the received scan instruction command or changing of existing instructions, thus performing extension of the command. In the third exemplary embodiment, the image adjustment setting (the contrast adjustment setting or the brightness adjustment setting) is not included in the scan instruction command generated by the universal scan software 202 in step S1201. Therefore, the extension application 204 adds the image adjustment setting (the contrast adjustment setting or the brightness adjustment setting).

In step S1204, the extension application 204 passes the extended scan instruction command to the universal scan software 202.

In step S1205, the universal scan software 202 transmits the scan instruction command to the scanning device 102, thus issuing a scan instruction.

In step S1206, the universal scan software 202 receives image data from the scanning device 102.

### [Sequence of Scan Processing (Image Editing)]

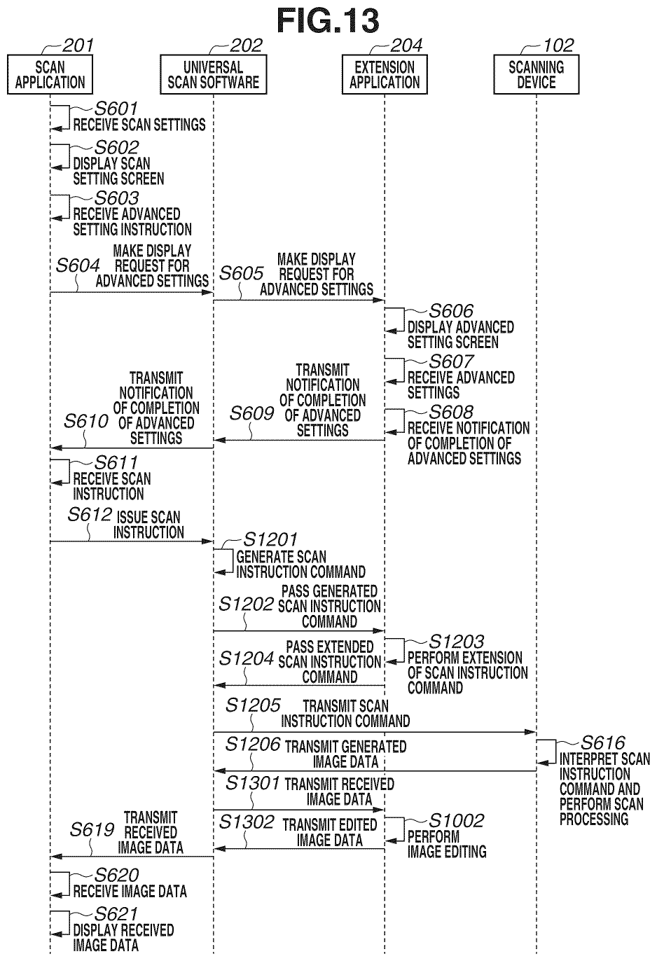

Next, a sequence of operations in which the extension application 204 performs image editing in a case where the universal scan software 202 and the scanning device 102 communicate with each other is described with reference to FIG. 13. Steps in common with those illustrated in FIG. 12 are assigned the respective same step numbers as those illustrated in FIG. 12 and are omitted from description here, and differences therebetween are mainly described. Furthermore, steps other than a step which is performed by the scanning device 102, illustrated in FIG. 13, are implemented by the CPU 111 reading out the scan application 201, the universal scan software 202, and the extension application 204 from the external storage device 114 onto the RAM 113 and executing them. The step which is performed by the scanning device 102 illustrated in FIG. 13 is implemented by the CPU 191 of the scanning device 102 reading out a program stored in the ROM 192 or the external storage device 199 onto the RAM 193 and executing the program.

In step S1301, the universal scan software 202 transmits the received image data to the extension application 204.

In step S1002, the extension application 204 performs image editing. In the third exemplary embodiment, the extension application 204 performs image adjustment (contrast adjustment or brightness adjustment) on the received image based on the image adjustment setting (contrast adjustment setting or brightness adjustment setting) set by the processing operation similar to that in step S1104A or S1104B illustrated in FIG. 11A or 11B.

In step S1302, the extension application 204 transmits the edited image data to the universal scan software 202.

As described above, in the third exemplary embodiment, the extension application 204 extends an image adjustment (contrast adjustment or brightness adjustment) designation command. This causes the scanning device 102 to implement the image adjustment function (the contrast adjustment function or the brightness adjustment function), thus enabling providing the image adjustment function (the contrast adjustment function or the brightness adjustment function) to the user.

Next, a fourth exemplary embodiment of the present disclosure is described. In the above-described first to third exemplary embodiments, a configuration in which a command to be used in the standard protocol is extended and the extended command is communicated to the scanning device 102 has been described.

In the fourth exemplary embodiment, a configuration in which a command to be used in the standard protocol is not extended and a different command is communicated to the scanning device 102 with respect to a function which is supported by only the extension application 204 is described.

Furthermore, in the following description, only differences from those in the above-described exemplary embodiments are described.

### [Sequence of Scan Processing (Different Command Transmission)]

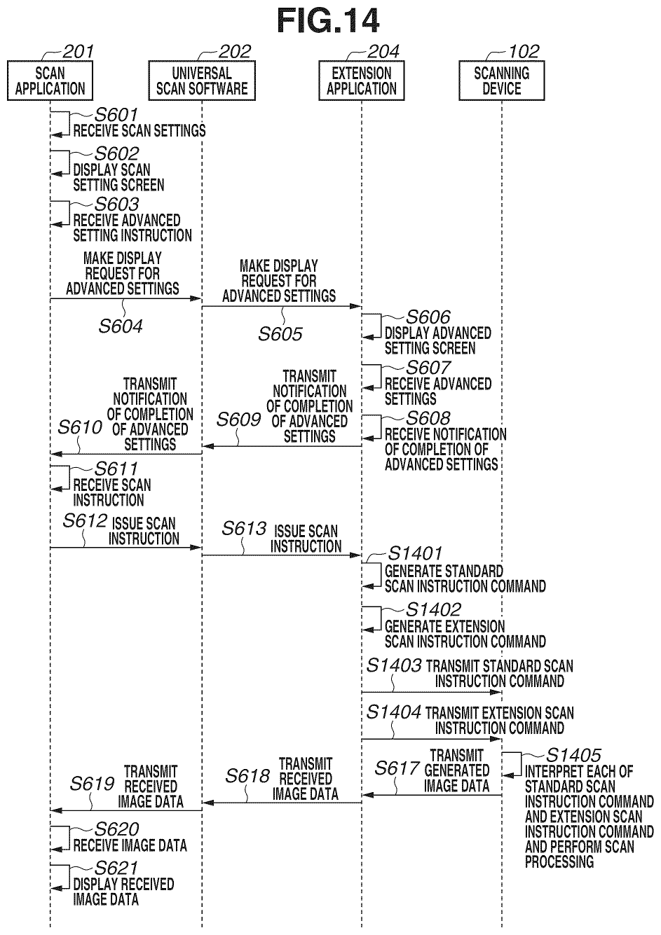

A sequence of operations of the scan application 201, the universal scan software 202, the extension application 204, and the scanning device 102 after the scan application 201 receives scan settings is described with reference to FIG. 14. Furthermore, steps other than a step which is performed by the scanning device 102, illustrated in FIG. 14, are implemented by the CPU 111 reading out the scan application 201, the universal scan software 202, and the extension application 204 from the external storage device 114 onto the RAM 113 and executing them. The step which is performed by the scanning device 102 illustrated in FIG. 14 is implemented by the CPU 191 of the scanning device 102 reading out a program stored in the ROM 192 or the external storage device 199 onto the RAM 193 and executing the program. Steps in common with those illustrated in FIG. 6 are assigned the respective same step numbers as those illustrated in FIG. 6 and are omitted from description here, and differences therebetween are mainly described.

In step S1401, the extension application 204 generates a standard scan instruction command compliant with the standard protocol. In this instance, a function which is not supported by the standard protocol is not written into the scan instruction command.

In step S1402, the extension application 204 generates an extension scan instruction command for a function which is supported by only the extension application 204.

In step S1403, the extension application 204 transmits the standard scan instruction command to the scanning device 102, thus issuing a scan instruction.

In step S1404, the extension application 204 transmits the extension scan instruction command to the scanning device 102, thus issuing a scan instruction.

In step S1405, the scanning device 102 interprets each of the received standard scan instruction command and the received extension scan instruction command and thus performs scan processing.

### <Scan Processing: Extension Application>

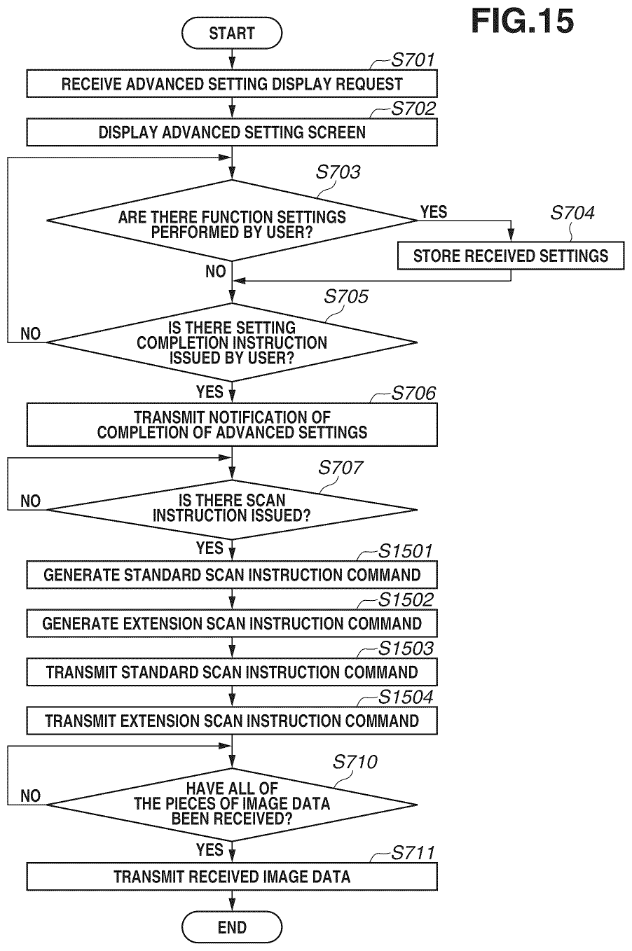

Here, a flowchart of processing which the extension application 204 performs to perform scan processing is described with reference to FIG. 15. Furthermore, steps in the flowchart are implemented by the CPU 111 reading out the respective units from the external storage device 114 onto the RAM 113 and executing the respective read-out units. Steps in common with those illustrated in FIG. 7 are assigned the respective same step numbers as those illustrated in FIG. 7 and are omitted from description here, and differences therebetween are mainly described.

Processing operations which are performed after the scan instruction is received in step S707 are described below.

In step S1501, the extension application 204 generates a standard scan instruction command compliant with the standard protocol.

In step S1502, the extension application 204 generates an extension scan instruction command for a function which is not supported by the standard protocol.

In step S1503, the extension application 204 transmits the standard scan instruction command generated in step S1501 to the scanning device 102.

In step S1504, the extension application 204 transmits the extension scan instruction command generated in step S1502 to the scanning device 102.

As described above, in the fourth exemplary embodiment, a different scan instruction command is transmitted from the extension application with respect to a function which is not supported by the standard protocol. This enables providing the image adjustment function (the contrast adjustment function or the brightness adjustment function) to the user.

Next, a fifth exemplary embodiment of the present disclosure is described.

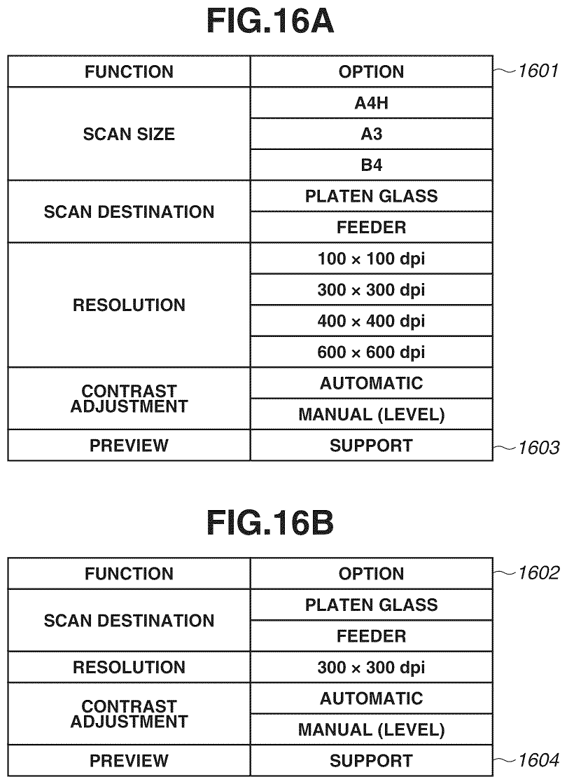

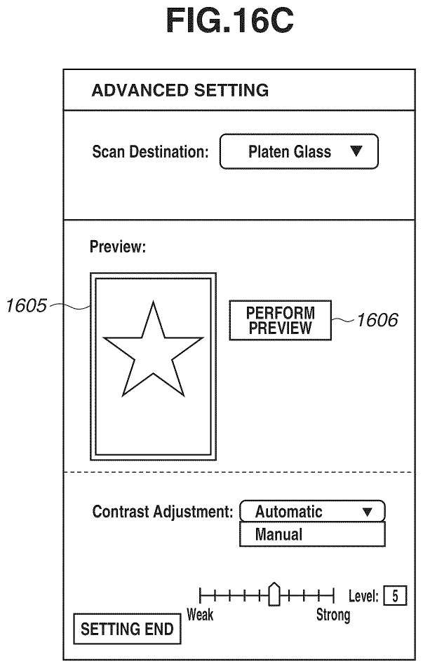

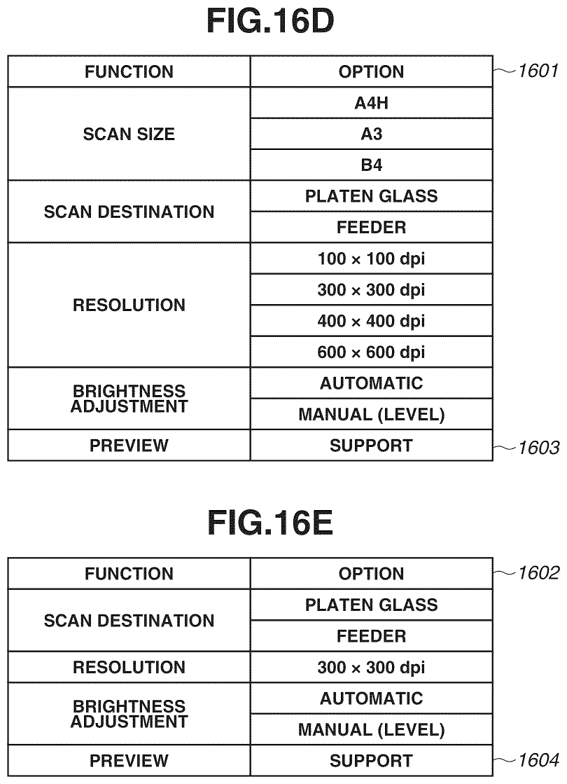

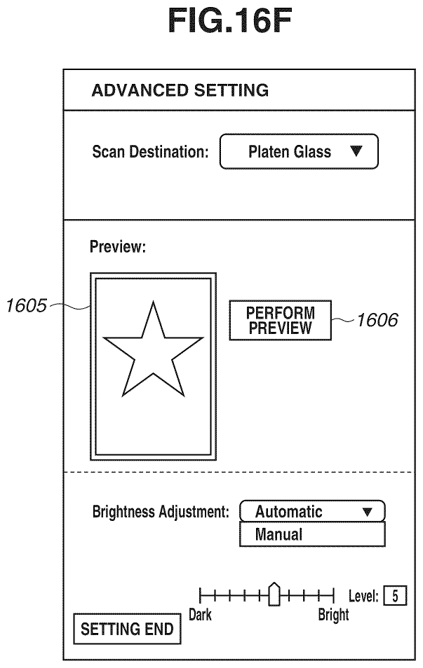

In the fifth exemplary embodiment, a method of displaying a preview image and performing scanning while allowing the user to check what image data is able to be acquired depending on a difference of setting values of image adjustment (contrast adjustment or brightness adjustment) is described. In the following description, only differences from those in the above-described exemplary embodiments are described with reference to FIGS. 16A, 16B, 16C, 16D, 16E, and 16F.

### <Contrast Adjustment>

FIG. 16A illustrates, as a table 1601, an example of a list of pieces of scan capability information acquired from the scanning device 102 in the fifth exemplary embodiment. As shown in the table 1601, information indicating that a preview function is supported (1603) is obtainable from the scanning device 102. As shown in a table 1602 illustrated in FIG. 16B, it is assumed that the extension application also supports preview (1604).

FIG. 16C illustrates an example of an advanced setting screen in which the preview function is available. In the advanced setting screen illustrated in FIG. 16C, a region 1605 for displaying a preview image and a control 1606 for issuing an instruction for performing preview are displayed. Furthermore, if contrast adjustment is set to manual, adjusting a slide bar enables performing contrast adjustment, and, in response to the control 1606 for preview execution being pressed, an image with contrast adjusted is displayed in the preview region 1605.

### <Brightness Adjustment>

FIG. 16D illustrates, as a table 1601, an example of a list of pieces of scan capability information acquired from the scanning device 102 in the fifth exemplary embodiment. As shown in the table 1601, information indicating that a preview function is supported (1603) is obtainable from the scanning device 102. As shown in a table 1602 illustrated in FIG. 16E, it is assumed that the extension application also supports preview (1604).

FIG. 16F illustrates an example of an advanced setting screen in which the preview function is available. In the advanced setting screen illustrated in FIG. 16F, a region 1605 for displaying a preview image and a control 1606 for issuing an instruction for performing preview are displayed. Furthermore, if brightness adjustment is set to manual, adjusting a slide bar enables performing brightness adjustment, and, in response to the control 1606 for preview execution being pressed, an image with brightness adjusted is displayed in the preview region 1605.

### [Sequence of Scan Processing (Preview)]

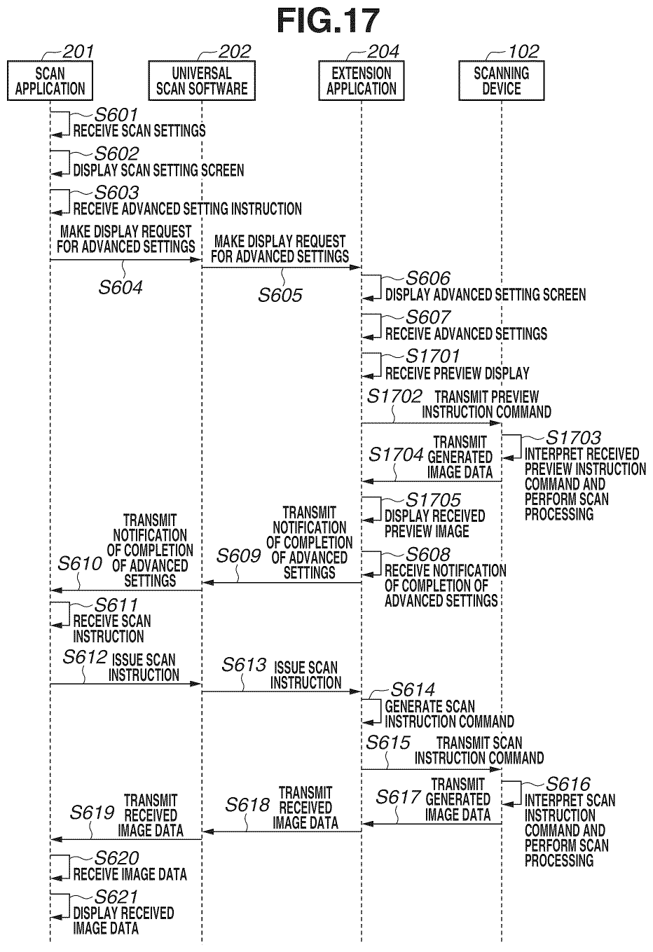

A sequence of operations of the scan application 201, the universal scan software 202, the extension application 204, and the scanning device 102 after the scan settings are received is described with reference to FIG. 17. Furthermore, steps other than steps which are performed by the scanning device 102, illustrated in FIG. 17, are implemented by the CPU 111 reading out the scan application 201, the universal scan software 202, and the extension application 204 from the external storage device 114 onto the RAM 113 and executing them. The steps which are performed by the scanning device 102 illustrated in FIG. 17 are implemented by the CPU 191 of the scanning device 102 reading out a program stored in the ROM 192 or the external storage device 199 onto the RAM 193 and executing the program. Steps in common with those illustrated in FIG. 6 are assigned the respective same step numbers as those illustrated in FIG. 6 and are omitted from description here, and differences therebetween are mainly described.

In step S1701, the extension application 204 receives preview display. The user is allowed to operate the pointing device 117 or the keyboard 118 to select the control 1606, thus issuing an instruction for preview display.

In step S1702, the extension application 204 transmits a preview instruction command to the scanning device 102, thus issuing a scan instruction for preview. For the scan instruction, the extension application 204 generates a preview instruction command based on the settings received at that point in time. In the fifth exemplary embodiment, the extension application 204 generates a preview instruction command including the received contrast adjustment.

In step S1703, the scanning device 102 interprets the received preview instruction command and thus performs scan processing. In the fifth exemplary embodiment, the scanning device 102 performs scan processing while performing image adjustment (contrast adjustment or brightness adjustment) designated by the preview instruction command.

In step S1704, the scanning device 102 transmits the generated image data to the extension application 204.

In step S1705, the extension application 204 displays the received preview image.

### <Scan Processing: Extension Application>

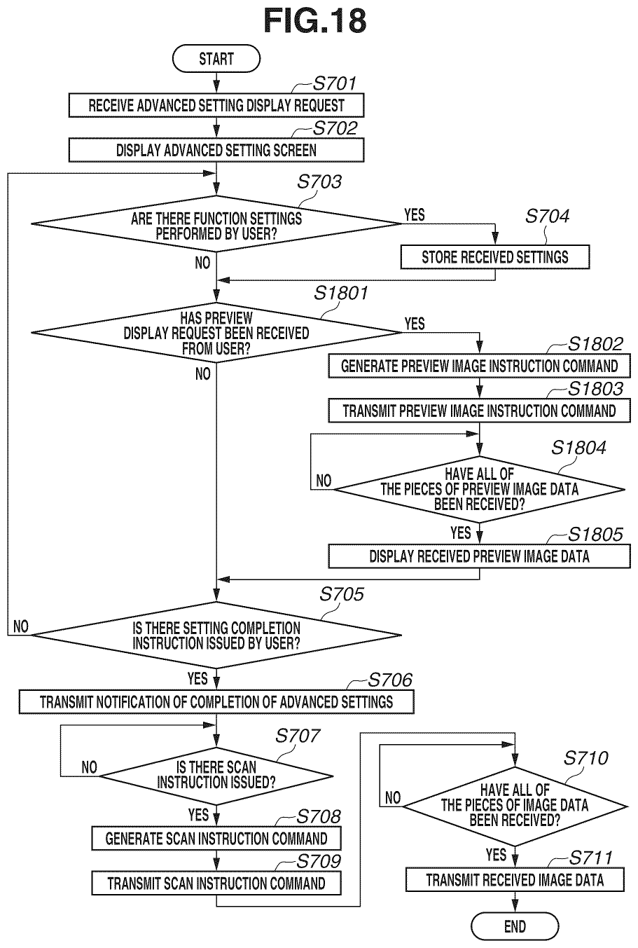

Here, a flowchart of processing which the extension application 204 performs to perform scan processing is described with reference to FIG. 18. Furthermore, steps in the flowchart are implemented by the CPU 111 reading out the respective units from the external storage device 114 onto the RAM 113 and executing the respective read-out units. Steps in common with those illustrated in FIG. 7 are assigned the respective same step numbers as those illustrated in FIG. 7 and are omitted from description here, and differences therebetween are mainly described.

In step S1801, the scan setting screen extension unit 205 determines whether a preview display request has been received from the user. If it is determined that a preview display request has been received (YES in step S1801), the CPU 111 advances the processing to step S1802, and, if not so (NO in step S1801), the CPU 111 advances the processing to step S705.

In step S1802, the extension application 204 generates a preview image instruction command based on setting information stored in step S704.

The method of generating a preview image instruction command in step S1802 includes, as with the scan instruction command, first, a method of extending a command defined in the standard protocol. The method of extension includes, for example, a method of writing a dedicated command into the extension region of the command defined in the standard protocol. Additionally, the method of extension includes, for example, a method of adding an original standard command to the tail end of the command defined in the standard protocol and a method in which the extension application 204 overwrites the command defined in the standard protocol with an original command system. Moreover, a configuration in which, when issuing an instruction, the extension application 204 performs an instruction and communication with a vendor-specific protocol irrespective of the standard protocol can be employed.

In step S1803, the extension application 204 transmits the preview image instruction command to the scanning device 102, thus issuing a scan instruction.

In step S1804, the extension application 204 determines whether all of the pieces of preview image data have been received from the scanning device 102. If it is determined that all of the pieces of preview image data have been received (YES in step S1804), the CPU 111 advances the processing to step S1805, and, if not so (NO in step S1804), the CPU 111 returns the processing to step $1804, in which the extension application 204 determines whether all of the pieces of preview image data have been received from the scanning device 102.

In step S1805, the extension application 204 displays the received preview image data, and then advances the processing to step S705.

While, in the fifth exemplary embodiment, the preview image is image data which is generated by the same processing as that for actual image data, a configuration of generating image data exclusively used for preview can be employed. For example, to speed up preview display, there are, for example, a method of decreasing resolution and a method of decreasing the image size by increasing the compression ratio.

Moreover, a configuration of deleting the preview image after reception of a notification indicating completion of the advanced setting in step S608 or at the time of cancellation of the advanced setting or a configuration of retaining the preview image until acquisition of final image data for the purpose of re-displaying the preview image when the advanced setting has been received again can be employed.

Next, a method in which, in a case where a change of settings has occurred after displaying of the preview image, if the image data editing unit 207 included in the extension application 204 is able to perform image processing, the image data editing unit 207 updates the preview image is described. In this case, without the scanning device 102 needing to perform scanning again, it is possible to provide an image of the intended product easily and at high speed to the user although the image is different from actual final image data. For example, in the case of contrast adjustment such as that in the fifth exemplary embodiment, changing setting values enables imagining how an image varies.

### <Preview Image Update Processing: Extension Application>

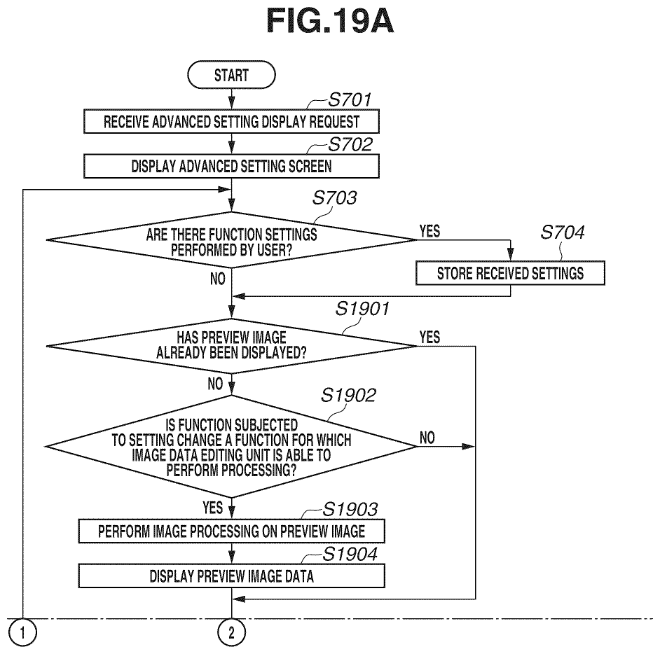

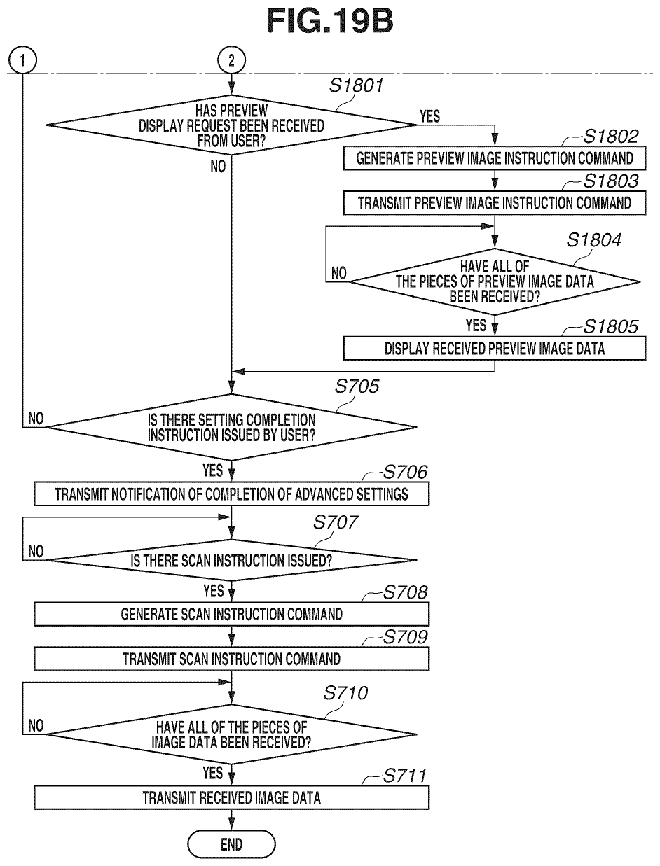

A flowchart of processing which the extension application 204 performs to update a preview image is described with reference to FIGS. 19A and 19B. Furthermore, steps in the flowchart are implemented by the CPU 111 reading out the respective units from the external storage device 114 onto the RAM 113 and executing the respective read-out units. Steps in common with those illustrated in FIG. 7 and FIG. 18 are assigned the respective same step numbers as those illustrated in FIG. 7 and FIG. 18 and are omitted from description here, and differences therebetween are mainly described.

In step S1901, the extension application 204 determines whether a preview image has already been displayed. If it is determined that a preview image has already been displayed (YES in step S1901), the CPU 111 advances the processing to step S1801, and, if it is determined that a preview image has not already been displayed (NO in step S1901), the CPU 111 advances the processing to step S1902.

In step S1902, the extension application 204 determines whether the function subjected to setting change received in step S703 is a function for which the image data editing unit 207 is able to perform processing. If it is determined that the function subjected to setting change is a function for which the image data editing unit 207 is able to perform processing (YES in step S1902), the CPU 111 advances the processing to step S1903. If it is determined that the function subjected to setting change is not a function for which the image data editing unit 207 is able to perform processing (NO in step S1902), the CPU 111 advances the processing to step S1801. In the fifth exemplary embodiment, since contrast adjustment is a function for which the image data editing unit 207 is able to perform processing, the CPU 111 advances the processing to step S1903.

In step S1903, the image data editing unit 207 performs image processing on the preview image.

In step S1904, the extension application 204 displays preview image data subjected to image processing.

In the above-described fifth exemplary embodiment, an example of displaying an image obtained by preview scanning performed by the scanning device has been described.

In a sixth exemplary embodiment of the present disclosure, a configuration in which, after displaying of a preview image, in a case where the user has determined to want to directly use previewed image data, without scanning being performed again, a preview image is actually passed to the scan application 201 is described.

### <Advanced Setting Screen>

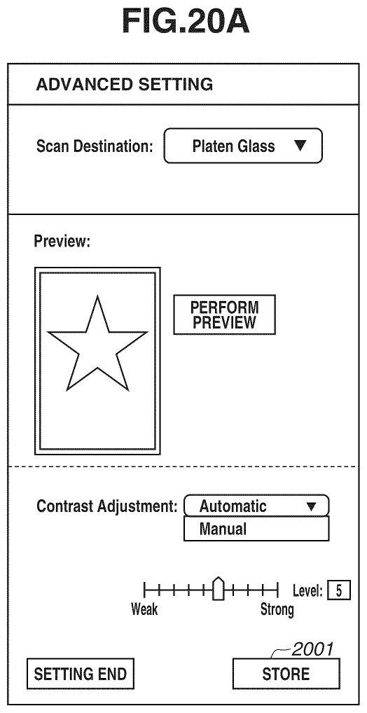

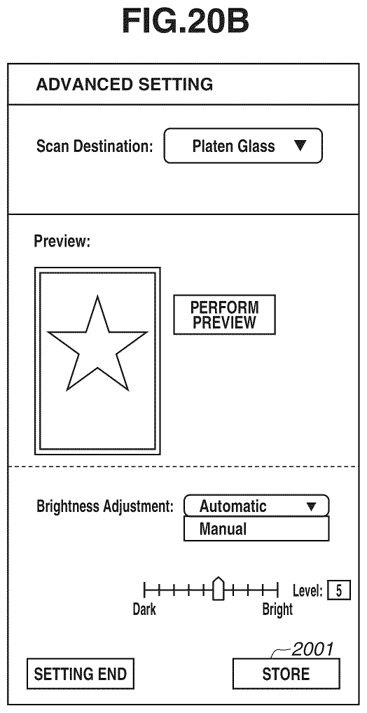

FIGS. 20A and 20B illustrate examples of advanced setting screens (contrast adjustment and brightness adjustment) each of which is available for storing a preview image. In the advanced setting screen, a control 2001 which is operable to issue an instruction for storing a preview image is displayed. In response to the control 2001 being pressed, processing for storing a preview image is performed.

### [Sequence of Scan Processing (Use of Preview Image Data)]

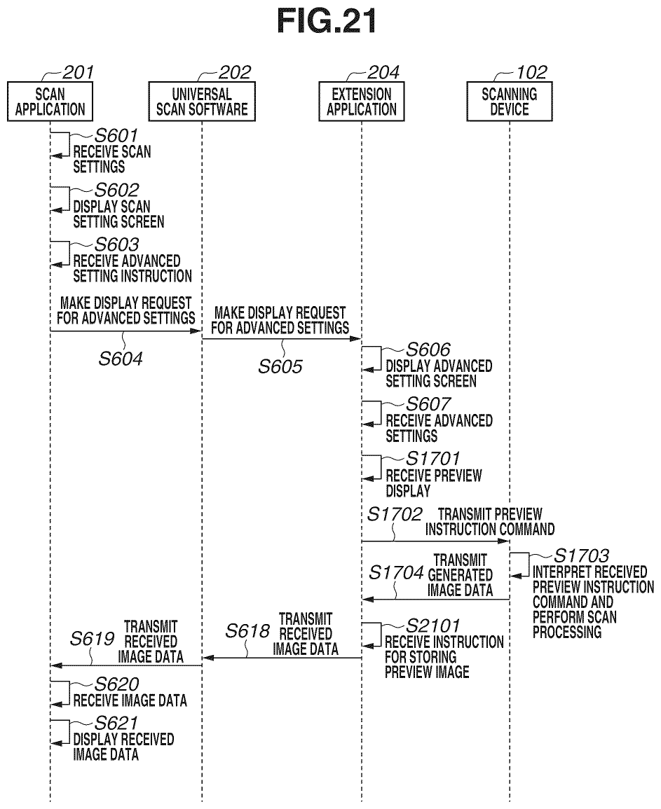

A sequence of operations of the scan application 201, the universal scan software 202, the extension application 204, and the scanning device 102 in the case of storing a preview image is described with reference to FIG. 21. Furthermore, steps other than a step which is performed by the scanning device 102, illustrated in FIG. 21, are implemented by the CPU 111 reading out the scan application 201, the universal scan software 202, and the extension application 204 from the external storage device 114 onto the RAM 113 and executing them. The step which is performed by the scanning device 102 illustrated in FIG. 21 is implemented by the CPU 191 of the scanning device 102 reading out a program stored in the ROM 192 or the external storage device 199 onto the RAM 193 and executing the program. Steps in common with those illustrated in FIG. 6 and FIG. 17 are assigned the respective same step numbers as those illustrated in FIG. 6 and FIG. 17 and are omitted from description here, and differences therebetween are mainly described.

In step S1704, the extension application 204 receives the scanned image.

In step S2101, the extension application 204 receives an instruction for storing the preview image. The user is allowed to operate the pointing device 117 or the keyboard 118 to select the control 1606, thus issuing an instruction for storing the preview image. In response to the instruction for storing, the extension application 204 passes the image data to the universal scan software 202. Then, the universal scan software 202 passes the image data to the scan application 201, so that the scan application 201 becomes able to handle the image data.

### <Scan Processing: Extension Application>

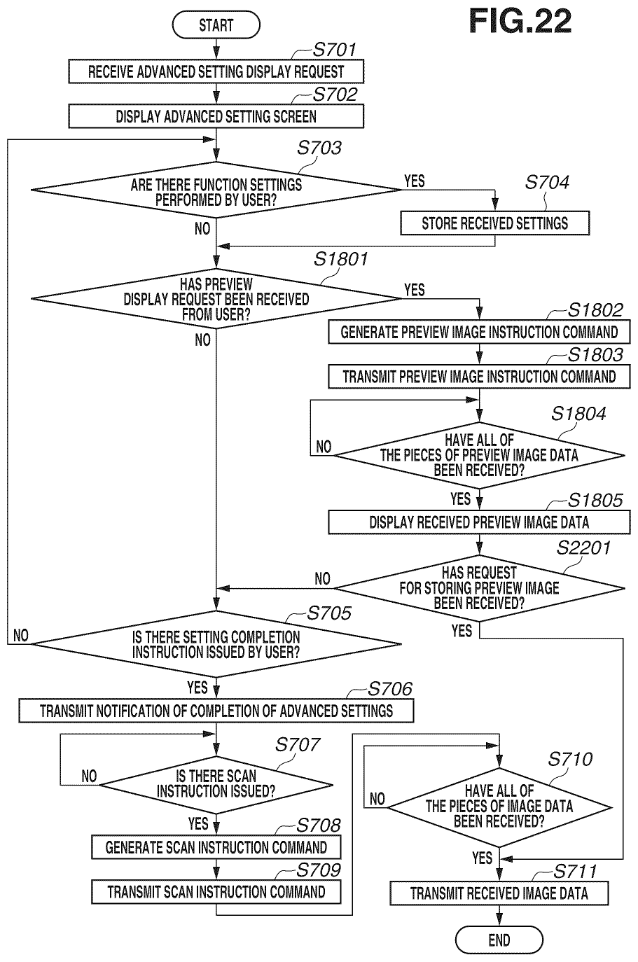

A flowchart of processing which the extension application 204 performs to perform scan processing is described with reference to FIG. 22. Furthermore, steps in the flowchart are implemented by the CPU 111 reading out the respective units from the external storage device 114 onto the RAM 113 and executing the respective read-out units. Steps in common with those illustrated in FIG. 7 and FIG. 18 are assigned the respective same step numbers as those illustrated in FIG. 7 and FIG. 18 and are omitted from description here, and differences therebetween are mainly described.

In step S2201, the scan setting screen extension unit 205 determines whether a request for storing the preview image has been received from the user. If it is determined that a request for storing the preview image has been received (YES in step S2201), the CPU 111 advances the processing to step S711, and, if it is determined that a request for storing the preview image has not been received (NO in step S2201), the CPU 111 advances the processing to step S705.

In step S711, the extension application 204 transmits the preview image data to the universal scan software 202.

Next, a configuration in which actual original data (actual data about an original) is not used as a preview image and the extension application 204 displays a preview image with use of preliminarily internally stored image data is described. Using preliminarily internally stored image data enables providing an image of the intended product easily and at high speed without the need for scan processing to the user although the image is different from actual image data. For example, in the case of image adjustment (contrast adjustment or brightness adjustment) such as that in the sixth exemplary embodiment, changing setting values enables imagining how an image varies.

### [Sequence of Scan Processing (Use of Stored Image Data)]

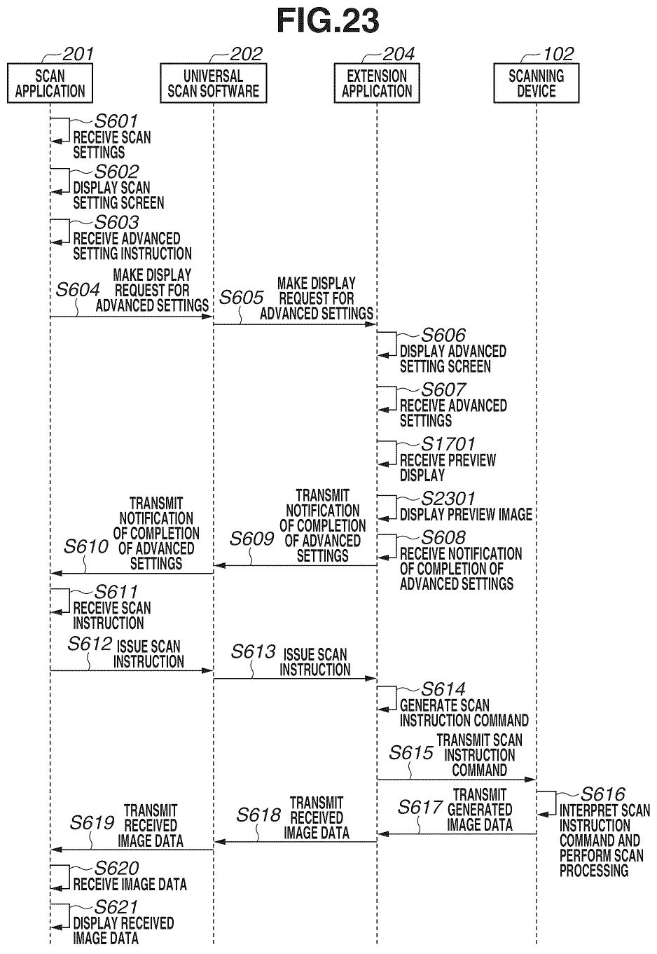

A sequence of operations of the scan application 201, the universal scan software 202, the extension application 204, and the scanning device 102 in the case of displaying a preliminarily stored preview image is described with reference to FIG. 23. Furthermore, steps other than a step which is performed by the scanning device 102, illustrated in FIG. 23, are implemented by the CPU 111 reading out the scan application 201, the universal scan software 202, and the extension application 204 from the external storage device 114 onto the RAM 113 and executing them. The step which is performed by the scanning device 102 illustrated in FIG. 23 is implemented by the CPU 191 of the scanning device 102 reading out a program stored in the ROM 192 or the external storage device 199 onto the RAM 193 and executing the program. Steps in common with those illustrated in FIG. 6 and FIG. 17 are assigned the respective same step numbers as those illustrated in FIG. 6 and FIG. 17 and are omitted from description here, and differences therebetween are mainly described.

In step S2301, the extension application 204 displays a preview image corresponding to the received settings.

With regard to a preview image to be displayed in this instance, a configuration in which a plurality of images for preview corresponding to various settings is separately stored and an image corresponding to a setting is selected from among the plurality of images for preview to be displayed or a configuration in which image processing is performed on specific image data for preview each time and the processed image data is displayed each time can be employed.

### <Scan Processing (Preview Image Updating): Extension Application>

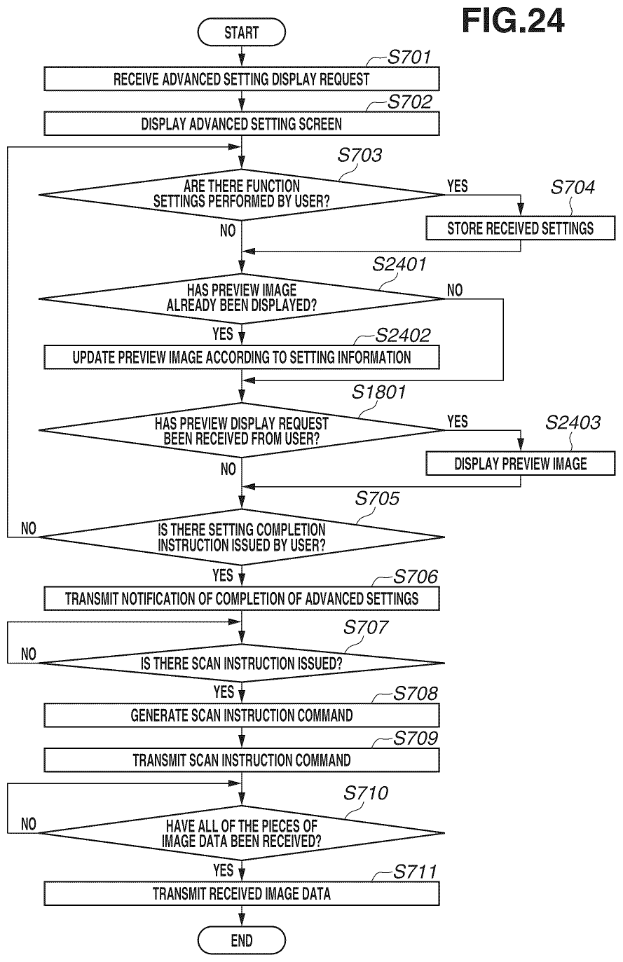

A flowchart of processing which the extension application 204 performs to update a preview image is described with reference to FIG. 24. Furthermore, steps in the flowchart are implemented by the CPU 111 reading out the respective units from the external storage device 114 onto the RAM 113 and executing the respective read-out units. Steps in common with those illustrated in FIG. 7 and FIG. 18 are assigned the respective same step numbers as those illustrated in FIG. 7 and FIG. 18 and are omitted from description here, and differences therebetween are mainly described.

In step S2401, the extension application 204 determines whether a preview image has already been displayed. If it is determined that a preview image has already been displayed (YES in step S2401), the CPU 111 advances the processing to step S2402, and, if not so (NO in step S2401), the CPU 111 advances the processing to step S1801.

In step S2402, the extension application 204 updates the preview image according to the settings and displays the updated preview image.

If, in step S1801, it is determined that a preview display request has been received from the user (YES in step S1801), the CPU 111 advances the processing to step S2403.

In step S2403, the extension application 204 displays a preview image according to the settings.

As described above, in the sixth exemplary embodiment, the extension application reuses and displays the stored preview image. Then, the extension application edits the preview image according to the settings, so that it becomes possible to provide, to the user, the image adjustment function (the contrast adjustment function or the brightness adjustment function) in such a way as to allow the user to readily imagine a final intended product.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-087100 filed May 29, 2024, which is hereby incorporated by reference herein in its entirety.

What is claimed is:

1. A non-transitory computer-readable storage medium storing an application program which causes an information processing apparatus to perform a control method, the control method comprising:
displaying a display screen for receiving a setting of contrast adjustment of an image which is scanned by an image processing device; and
outputting, with use of universal scan software, a scan instruction for causing the image processing device to perform scanning of an image according to the setting received via the display screen,
wherein the application program supports the universal scan software, which is capable of outputting a scan instruction interpretable by a plurality of image processing devices from various manufacturers.

2. The non-transitory computer-readable storage medium according to claim 1, wherein the display screen for receiving the setting is a screen for changing an item which is displayed based on a capability of scan of an image processing device.

3. The non-transitory computer-readable storage medium according to claim 2, wherein the setting includes a setting for automatically adjusting an image to be scanned.

4. The non-transitory computer-readable storage medium according to claim 2, wherein the setting includes a setting for causing a user to manually adjust an image to be scanned.

5. The non-transitory computer-readable storage medium according to claim 1, wherein the control method further comprises:
determining whether the received setting of contrast adjustment is able to be performed in the image processing device; and
if it is determined that the received setting of contrast adjustment is not able to be performed in the image processing device, performing, on image data acquired by scanning, image contrast adjustment processing based on the received setting of contrast adjustment.

6. The non-transitory computer-readable storage medium according to claim 5, wherein the control method further comprises:
determining whether the received setting of contrast adjustment is able to be performed in the image processing device; and
if it is determined that the received setting of contrast adjustment is not able to be performed in the image processing device, outputting, to the image processing device, an instruction command which does not include an instruction for contrast adjustment.

7. The non-transitory computer-readable storage medium according to claim 1, wherein the control method further comprises outputting the scan instruction to the image processing device via the universal scan software.

8. The non-transitory computer-readable storage medium according to claim 1, wherein the control method further comprises, when issuing a scan instruction to the image processing device for performing scanning, transmitting an instruction command obtained by extending an instruction command defined in a standard protocol.

9. The non-transitory computer-readable storage medium according to claim 1, wherein the control method further comprises, when issuing a scan instruction to the image processing device for performing scanning, transmitting a unique instruction command without transmitting an instruction command defined in a standard protocol.

10. The non-transitory computer-readable storage medium according to claim 1, wherein the control method further comprises, when issuing a scan instruction to the image processing device for performing scanning, transmitting an extended instruction command separately from an instruction command defined in a standard protocol.

11. The non-transitory computer-readable storage medium according to claim 1, wherein the control method further comprises outputting a scan instruction to the image processing device based on the received setting, and displaying an image obtained by the image processing device performing scanning as a preview image on the display screen.

12. The non-transitory computer-readable storage medium according to claim 11, wherein the control method further comprises, when outputting a scan instruction to the image processing device, transmitting an instruction command for a preview image.

13. The non-transitory computer-readable storage medium according to claim 11, wherein the control method further comprises receiving, via the display screen, whether to store the preview image.

14. The non-transitory computer-readable storage medium according to claim 1, wherein the control method further comprises displaying image data stored based on the setting received via the display screen as a preview image.

15. The non-transitory computer-readable storage medium according to claim 14, wherein the control method further comprises, with respect to the preview image, updating the preview image based on the received setting.

16. A non-transitory computer-readable storage medium storing an application program which causes an information processing apparatus to perform a control method, the control method comprising:
displaying a display screen for receiving a setting of brightness adjustment of an image which is scanned by an image processing device; and
outputting, with use of universal scan software, a scan instruction for causing the image processing device to perform scanning of an image according to the setting received via the display screen,
wherein the application program supports the universal scan software, which is capable of outputting a scan instruction interpretable by a plurality of image processing devices from various manufacturers.

17. The non-transitory computer-readable storage medium according to claim 16, wherein the control method further comprises:
determining whether the received setting of brightness adjustment is able to be performed in the image processing device; and
if it is determined that the received setting of brightness adjustment is not able to be performed in the image processing device, performing, on image data acquired by scanning, image brightness adjustment processing based on the received setting of brightness adjustment.

18. The non-transitory computer-readable storage medium according to claim 17, wherein the control method further comprises:
determining whether the received setting of brightness adjustment is able to be performed in the image processing device; and
if it is determined that the received setting of brightness adjustment is not able to be performed in the image processing device, outputting, to the image processing device, an instruction command which does not include an instruction for brightness adjustment.

19. A control method for an information processing apparatus including universal scan software capable of outputting a scan instruction interpretable by a plurality of image processing devices from various manufacturers and an application which supports the universal scan software, the control method comprising:
displaying a display screen for receiving a setting of contrast adjustment of an image which is scanned by an image processing device; and
outputting a scan instruction for causing the image processing device to perform scanning according to the setting received via the display screen.

20. A control method for an information processing apparatus including universal scan software capable of outputting a scan instruction interpretable by a plurality of image processing devices from various manufacturers and an application which supports the universal scan software, the control method comprising:
displaying a display screen for receiving a setting of brightness adjustment of an image which is scanned by an image processing device; and
outputting a scan instruction for causing the image processing device to perform scanning according to the setting received via the display screen.

21. An information processing apparatus including universal scan software capable of outputting a scan instruction interpretable by a plurality of image processing devices from various manufacturers and an application which supports the universal scan software, the information processing apparatus comprising:
a display unit configured to display a display screen for receiving a setting of contrast adjustment of an image which is scanned by an image processing device; and
an output unit configured to output a scan instruction for causing the image processing device to perform scanning according to the setting received via the display screen.

22. An information processing apparatus including universal scan software capable of outputting a scan instruction interpretable by a plurality of image processing devices from various manufacturers and an application which supports the universal scan software, the information processing apparatus comprising:
a display unit configured to display a display screen for receiving a setting of brightness adjustment of an image which is scanned by an image processing device; and
an output unit configured to output a scan instruction for causing the image processing device to perform scanning according to the setting received via the display screen.
